(19) United States
(12) Patent Application Publication
(10) Pub. No.: US 2022/0219882 A1
(43) Pub. Date: Jul. 14, 2022

(54) SYSTEM AND METHOD FOR RELIABLY DISPENSING PRE-PACKAGED PHARMACEUTICALS

(71) Applicant: spencer Health Solutions, LLC, Durham, NC (US)

(72) Inventors: Jeremy Scott Bridges, Apex, NC (US); John Michael Burton, JR., Durham, NC (US); Paul Joseph Cunningham, Hillsborough, NC (US); Michael L. King, Durham, NC (US); Benjamin Lane, Hydes, MD (US); Aaron Pearl, Baltimore, MD (US); Luke Luehr, Ashburn, VA (US)

(21) Appl. No.: 17/559,386

(22) Filed: Dec. 22, 2021

Related U.S. Application Data
(63) Continuation of application No. 15/710,503, filed on Sep. 20, 2017, now abandoned.
(60) Provisional application No. 62/398,652, filed on Sep. 23, 2016.

(51) Int. Cl. B65D 83/08; A61J 7/00; A61J 7/04; B65D 85/671

(52) U.S. Cl. CPC B65D 83/0805; A61J 7/0084; A61J 7/0481; A61J 2205/60; A61J 2205/30; A61J 2205/10; B65D 85/671

(57) ABSTRACT

The present specification describes a medicine dispensing system for automatically dispensing medication at a predetermined time. The system includes a cartridge that carries a strip of medicine pouches. When the cartridge is dropped into a dispensing unit, it automatically aligns with the dispensing unit without requiring any installation work from the user. The automatic alignment is enabled because of self-aligning features manufactured in the cartridge housing. The cartridge includes a flapper baffle that assists the conveyance of the strip of pouches through the dispensing unit.

### RELATED APPLICATIONS

The present application is a continuation of and claims priority to U.S. patent application Ser. No. 15/710,503, filed Sep. 20, 2017, which claims priority from and the benefit of U.S. Provisional Patent Application No. 62/398,652, filed Sep. 23, 2016, the disclosure of each of which is hereby incorporated herein in its entirety.

### FIELD

The present invention relates generally to devices for dispensing items, and more specifically, to systems and methods for assisting patients in taking prescription medication, in accordance with a desired regimen prescribed by a physician.

### BACKGROUND

Even with the present day advances in medicines and healthcare, people, especially senior citizens and disabled persons, face a number of challenges in taking care of their health at home. Typically there is little assistance for the ‘home patient’ in managing multiple prescriptions and inventories of medicines. According to some estimates, the average senior person is prescribed up to thirteen different oral medications that must be taken correctly at different times each day. These medications are typically delivered in bulk supply and must be sorted, managed, and then taken correctly by the individual, leading to numerous errors and omissions, including failing to take the medications at the prescribed time, taking the medications at the wrong time and/or in the incorrect amount, misusing the medications, fatally combining the medications with other medications, under-using the medications, or over-using the medications, collectively referred to “non-compliance.”

The costs associated with such non-compliance are higher than the costs associated with a number of major illnesses. Studies have shown that 10% of admissions to regular hospitals in the United States are due to non-compliance, at a cost of $15 billion a year, and 30% of hospital admissions for people over the age of 65 are directly caused by non-compliance. Non-compliance causes 125,000 deaths per year—twice as many as are caused by auto accidents. Twenty-three percent to forty percent of nursing home admissions are due to noncompliance and inability to take medications at home unsupervised. According to estimates, nearly half of all prescriptions are taken incorrectly, contributing to prolonged or additional illness. People who miss doses need 3 times as many doctor visits as others and face an average of $2,000 more in medical costs per year.

The fact that the aging population continues to grow, combined with the steady increase in the average number of medications prescribed per person, indicates that these issues will continue to compound along with the associated costs.

In order to ensure that medications are taken at the proper time, a variety of devices, such as the ones disclosed in U.S. Pat. Nos. 4,361,408 and 7,944,342, have been devised to generate audible and/or visible prompting or alarm signals that remind a patient or his caretaker to administer the correct dosages at the correct time. Various dispensing devices have also been developed to help patients adhere to their medication protocols or regimens. Examples of such devices are provided in U.S. Pat. Nos. 8,060,246 and 8,196,774.

There may be a need for a simple yet efficient system that not only reminds a patient to take medication according to their prescribed schedule, but also provides the required medicines to the patient in a simple, convenient and reliable manner.

### SUMMARY

As a first aspect, embodiments of the invention are directed to a cartridge for a pharmaceutical dispensing system, comprising: a frame with opposed sidewalls and having a floor and a base, the floor positioned above the base and including a routing hole; and a plurality of individually sealed pouches of pharmaceuticals to be dispensed, the pouches formed as an elongate strip, the strip of pouches being wound into a roll over an axle member that extends between the sidewalls of the frame. A free end of the strip extends through the routing hole in the floor and between the floor and the base. A flapper baffle extends from the floor to separate the roll from the free end of the strip.

As a second aspect, embodiments of the invention are directed to a pharmaceutical dispensing system comprising: a housing with an opening, the housing having an internal compartment and a delivery outlet; a drive unit mounted in the housing; and a cartridge as described above.

As a third aspect, embodiments of the invention are directed to a method of loading a pharmaceutical dispensing system, comprising the steps of:

(a) providing a cartridge as described above;

(b) providing a pharmaceutical dispensing system comprising:
a housing with an opening, the housing having an internal compartment and a delivery outlet; and
a drive unit mounted in the housing; and

(c) inserting the cartridge into the housing through the opening in the housing and into the compartment of the housing such that the free end of the strip is positioned adjacent the drive unit so that operation of the drive unit conveys the free end of the strip toward the delivery outlet.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 is a schematic diagram that illustrates an overall arrangement that is utilized by the present system for dispensing medicines;

FIG. 2 is a top view of an exemplary pouch of medication, attached to a strip of pouches in a roll, to be dispensed by a dispensing system according to embodiments of the invention;

FIG. 3A is a front perspective view of an exemplary cartridge:

FIG. 3B is a rear perspective view of the cartridge of FIG. 3A;

FIG. 4 is a perspective view of a dispensing unit according to embodiments of the invention;

FIG. 5A is a front perspective view of the cover of a cartridge for use with the dispensing unit of FIG. 4;

FIG. 5B is a rear perspective view of the cover of the cartridge of FIG. 5A;

FIG. 6 is a perspective view of a cartridge frame loaded with a strip of medication pouches for use with the cartridge of FIG. 3A;

FIG. 7 is a front perspective view of a cartridge frame of FIG. 6 without the cylinder;

FIG. 8 is a perspective view of two modular halves of the cylinder portion of the cartridge of FIG. 3A;

FIG. 9 is a perspective view of the halves of FIG. 8 in an assembled condition;

FIG. 10 is a front perspective view of the cartridge frame and cylinder of the cartridge of FIG. 3A;

FIG. 11A is a rear perspective view of the cartridge frame of FIG. 7;

FIG. 11B is a top view of the cartridge frame of FIG. 11A showing the floor of the cartridge:

FIG. 12A is a section view of the cartridge frame of FIG. 10;

FIG. 12B is a section view of the cartridge frame of FIG. 10 with a medication strip loaded on the cylinder and following its path through the frame;

FIG. 13 is a top view of the base of the cartridge of FIG. 3A;

FIG. 14 is a bottom view of the base of the cartridge of FIG. 3A;

FIG. 15 is perspective view of the flattened form of the cartridge frame of FIG. 3A;

FIG. 16 is a perspective view of the opposite side of the flattened form of the cartridge frame of FIG. 15;

FIG. 17A is a top perspective view of the dispensing unit of FIG. 4 with the top door removed to show the compartment into which the cartridge fits;

FIG. 17B is a top perspective view of the dispensing unit of FIG. 17A, showing the other side of the compartment;

FIG. 17C is a top view of the dispensing unit of FIG. 17A showing the bottom of the compartment;

FIG. 18 is a perspective section view of the dispenser of FIG. 17A with a cartridge loaded in it;

FIG. 19A is a side section view of the dispenser of FIG. 17A with a cartridge loaded in it, showing the dispensing path of the medication strip;

FIG. 19B is a side section view of the dispenser of FIG. 17A with a cartridge loaded in it, showing the exception path of a medication pouch;

FIG. 20 is a flow chart of the operational flow of the dispensing unit of FIG. 4:

FIG. 21 is a chart of the mechanical flow of the dispensing unit of FIG. 4;

FIG. 22 is a chart of the manual dispense flow of the dispensing unit of FIG. 4;

FIG. 23 is a flow chart of the validation of cartridge data during the cartridge load process of the dispensing unit of FIG. 4;

FIGS. 24A, 24B and 25 are a flow chart of the validation of pouch data during the pouch dispensing process of the dispensing unit of FIG. 4;

FIG. 26 is a top view of an exemplary pouch of medication to be dispensed by a dispensing system according to embodiments of the invention;

FIG. 27A is a perspective view of a cartridge according to alternative embodiments of the invention;

FIG. 27B is a perspective view of one half of the cartridge of FIG. 27A with the free-spinning hub shown therein;

FIG. 27C is an enlarged reverse partial perspective view of the cartridge of FIG. 27A installed in a dispenser, with a spring for maintaining the pouches in position;

FIG. 27D is an enlarged partial perspective view of the cartridge of FIG. 27A in a dispenser with a spring release mechanism for releasing the spring shown in FIG. 27C;

FIG. 28 is a perspective view of a portion of the dispenser of FIG. 27C with a cartridge of FIG. 27A loaded therein, showing an embodiment for placement of cameras to read the barcodes on the cartridge and pouches;

FIG. 29A is a perspective view of the door locking mechanism of the dispenser of FIG. 32 shown in the unlocked position;

FIG. 29B is a perspective view of the door locking mechanism of FIG. 29A shown in the locked position;

FIG. 29C is a perspective view of the cam of the door locking mechanism of FIG. 29A shown in the locked position;

FIG. 29D is a perspective view of the cam of the door locking mechanism of FIG. 29A shown in the unlocked position;

FIG. 29E is a perspective view of the door sensor of the door locking mechanism of FIG. 29A:

FIG. 30A is a partial perspective view of the inside of the dispenser door, loaded with a cartridge and the door closed, showing a spring-loaded bracket located on the inside of the door;

FIG. 30B is a partial perspective view of the spring loaded bracket of FIG. 30A without a cartridge;

FIG. 31 is a perspective view of a cartridge according to additional embodiments of the invention:

FIG. 32 is a perspective view of a dispenser according to additional embodiments of the invention;

FIG. 33 is a perspective view of a cartridge cover of the cartridge of FIG. 31;

FIG. 34 is a perspective view of a cartridge frame of the cartridge of FIG. 31 with a pouch strip mounted therein;

FIG. 35 is a perspective view of the cartridge frame of FIG. 34 without the hub/axle and pouch strip;

FIG. 36 is a perspective view of the free-spinning hub/axle of the cartridge frame of FIG. 34;

FIG. 37 is a perspective view of the cartridge frame of FIG. 34 without the pouch strip:

FIG. 38 is a top view of the cartridge frame of FIG. 34;

FIG. 39 is a section view of the cartridge frame of FIG. 34, including the pouch strip and hub;

FIG. 40 is a bottom section view of the cartridge frame of FIG. 34; and

FIG. 41 is a section view of the dispenser of FIG. 32, without a cartridge loaded therein.

FIG. 42A is a partial perspective view of the cartridge frame with a flapper baffle included therein according to alternative embodiments of the invention.

FIG. 42B is a partial side view of the cartridge frame and flapper baffle of FIG. 42A.

FIG. 42C is a partial perspective view of the cartridge frame with a flapper baffle included therein according to further embodiments of the invention.

FIG. 42D is a partial side view of the cartridge frame and flapper baffle included therein according to still further embodiments of the invention.

### DETAILED DESCRIPTION

The present specification discloses a method and system that assists people at home in taking medication according their prescribed regimen. In one embodiment, the present system reminds a patient to take their medication at the scheduled time, and also provides all the required medicines to be taken at that time in one or more convenient pouches. The system may be useful for patients taking medication on a daily schedule, patients participating in a clinical study, or anyone needing to take medications, supplements, etc. on a regular, consistent basis.

In one embodiment, the present system allows a user to simply drop a cartridge into a receptacle and have the medicine pouches with the appropriate medication dosages dispensed at the requisite times, without the need for any programming, installation, aligning, fitting or other work. In one embodiment, the cartridge contains pouches of medicines spooled around a cartridge cylinder, which is used to dispense pouches as and when required. The cartridge is typically mailed or otherwise delivered to or received by the person on a regular basis.

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

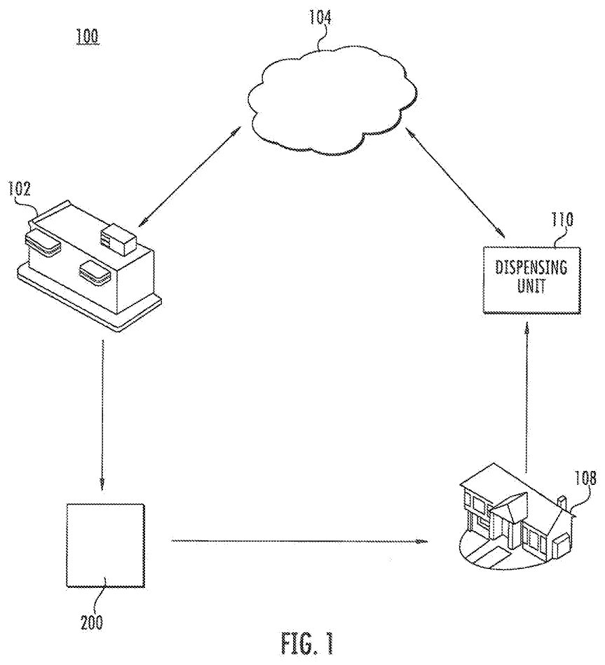

As described above, the invention relates generally to a system and process for dispensing pharmaceuticals. A high level process incorporating the invention is described generally with reference to FIG. 1. The process begins with a medicine supplier 102, such as a pharmacy, that receives and processes prescriptions for a patient in any suitable manner. In one embodiment, the prescriptions are sent to the medicine supplier 102 through a network, computer system, a cloud or any other communication mechanism 104, or they may originate through a paper prescription provided to the medicine supplier by the patient, as received from their physician or via a phone call or fax from a physician. Such prescriptions also may be refills of previously filled prescriptions for the patient. The medicine supplier packages the medications in pouches, according to the time that the medication is to be taken by the patient. Exemplary systems for the packaging of medications in pouches are described in U.S. Pat. Nos. 5,671,592 and 6,202,385, and are herein incorporated by reference in their entirety. Medications that are to be taken at the same time are packaged in the same pouch and each pouch is assigned a time of administration, in accordance with the prescription(s). It should be noted that more than one pouch may be required to package all the medications for a given administration time. For the sake of simplicity, a single pouch will be referred to herein, but should be understood to include one or more pouches, as necessary to accommodate a patient's medication regimen. U.S. Pat. No. 8,311,853 describes an exemplary system that can be used to assign administration times for groups of medications and align the refills for the prescriptions to facilitate the refill process for all medications packaged in the pouches for a single patient and is herein incorporated by reference in its entirety. In one embodiment, a series of pouches are connected together to form a strip, such that a pouch may be removed from the strip, one at a time, through a cutting, tearing, or other removal mechanism. Pouches are ordered in the strip in chronological order, based on the date and time of administration. In one embodiment, a strip of medication pouches is loaded in a cartridge 200 (as shown in FIG. 6), and sent to the user's home 108. In one embodiment, the cartridge 200 is sent periodically to the patient, and the periodicity is based on the patient's preference—such as every week, every ten days, or once per month. The cartridge 200 contains medicines sufficient to last the predetermined period of time.

At the patient's home, the cartridge of packaged prescription medication is loaded by the patient into a dispensing unit 110. In one embodiment, the cartridge 200 is designed to automatically self-align with the dispensing unit 110, without the need for any installation work on the user's part. Therefore, the user may simply drop the cartridge 200 into the housing of dispensing unit 110 and apply sufficient pressure (either manually or via a mechanism in the dispenser) to cause the cartridge to seat in place (some embodiments employ a snapping action). Once the cartridge 200 seats in place, it is automatically aligned with the dispensing mechanisms and capable of dispensing medicines without further work, adjustment, or installation by the user as described in more detail below.

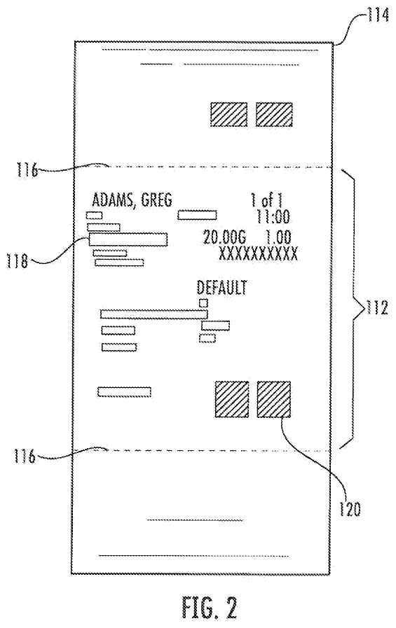

FIG. 2 illustrates exemplary pouches of medication, with each pouch containing the medicines to be taken by the patient at a particular time of administration, in accordance with their prescription(s). Individual pouches of medicine 112 are connected together to form a medication strip 114, which is loaded into a cartridge 200. In one embodiment, the number of pouches 112 in the strip 114 depends on the number of days for which the patient has ordered the medicines. Thus, for example, a patient may order prescription medicines for one week; then the number of pouches 112 in the strip 114 corresponds to the number of times the patient has to take medicines each day times seven days. In one embodiment the patient may have a schedule established with the medicine supplier to automatically receive a new strip of pouches on a regular basis (i.e., every two weeks, once per month, etc.)

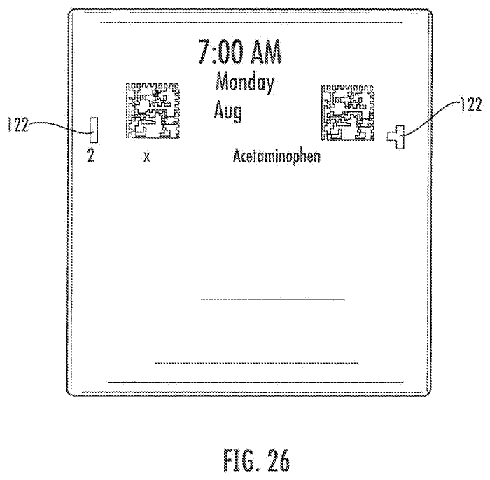

Thus, one or more single or multi-medicine pouches 112 are prepared for each medication administration time for a predetermined period of time, and connected in the correct sequence to form a strip 114. The medication administration time may be time based or event based. For example, the administration time may be “9.00 a.m.” or “Breakfast”. FIG. 26 illustrates another exemplary pouch in which the administration time is indicated as “7:00 AM, Monday, Aug 01”. Individual pouches may be separated along the strip 114 by a transverse perforation or seam 116 that allows for easy separation of the pouches from the strip one at a time. Individual medicine pouches may be labeled with information 118, such as the name of the patient, date of packaging or manufacturing, expiry date(s) of the medications, date and time of administration, instructions for taking the medication (i.e., take with food), warnings (i.e., do not operate heavy machinery when taking this medication, do not drink alcohol when taking this medication), and pouch contents, including the name, dosage, and number of pills of each medication; such information may be modified as necessary to comply with state and/or federal regulations. The medicine pouches 112 may each include a bar code 120 for identifying the individual pouch 112. The bar code 120 may also contain some or all of the information 118. In some embodiments, the bar code 120 may contain a unique pouch ID. The bar code 120 also may include an encoded index which determines its order within the strip 114 and may be used to determine the dispense time for that pouch 112. Each bar code 120 also may contain information about the prior pouch 112 and/or the subsequent pouch 112. This information can be used in processes for error recovery when the data collected from a bar code 120 is incomplete or determined to be invalid, as discussed below. Pouches 112 may include duplicate bar codes 120 located in separate areas of the pouch 112 (for example, in either corner). Identification of pouches 112 may additionally or alternatively be accomplished by RFID tag, colors, symbols, etc. Pouches 112 may include one or more registration symbols 122 that may be used to facilitate pouch 112 detection, particularly when using computer vision applications. Registration symbols 122 may be of any appropriate shape or size suitable for detection such as, for example, T-shaped, a vertical line, horizontal line, bar, dot, etc. and may be located in any appropriate area of the pouch 112. In one embodiment, the pouches 112 are made from any suitable material that meets federal requirements for medication packaging and is of any size suitable to properly accommodate medications and the dispensing unit 110.

It may be noted that the medicine supplier 102 that packages the medication into the pouches 112/strip 114 may be a pharmacy themselves, or may be a third party with which the pharmacy has contracted for packaging/distributing the medications.

After the medications are packaged into pouches 112 corresponding to the appropriate doses for each time of administration for a single patient, the strip 114 of pouches for that patient is loaded into a dispensing cartridge 200. Each cartridge 200 is loaded with medicine pouches 112 sufficient to last a predetermined time frame specified by the patient, as explained above. The cartridge 200 with loaded medicines may be mailed, or otherwise delivered, to the patient on a regular basis. The cartridge 200 then can be loaded into a dispensing unit 110 for the patient and the individual pouches 112 can be dispensed at the appropriate times of administration. When the medication pouches 112 have all been dispensed, the used cartridge 200 may be disposed of, recycled, or may be returned to the medicine supplier 102, or other designated facility, for reuse.

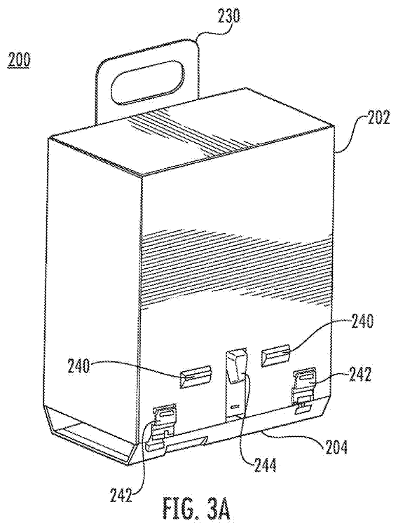

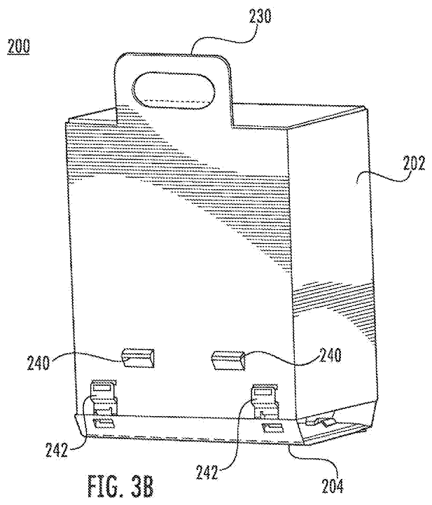

FIGS. 3A and 3B illustrate an exemplary cartridge 200 which comprises a cartridge cover 202 and a cartridge frame 204. Cartridge 200 also comprises a cylinder 206 about which the medication strip 114 is wound (see, e.g., FIG. 6). Any discussion herein that references the loading of a cartridge 200 into a dispensing unit 110, includes the medication strip 114 loaded in the cartridge 200.

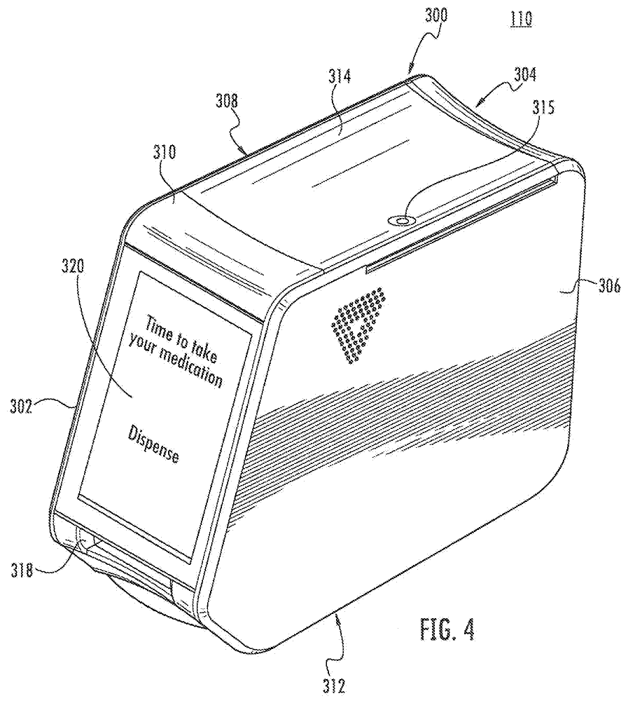

FIG. 4 illustrates an exemplary dispensing unit 110. As can be seen in FIG. 4, dispensing unit 110 comprises a housing 300 with a front 302, back 304, sides 306, 308, top 310 and bottom 312. Top 310 includes a door 314 which is openable to expose an opening 316 in the housing 300; the opening 316 provides access to the compartment 322 for receiving a cartridge 200 as described above. In the given example, an opening 316 is defined on the top 310 of the dispenser housing 300 such that the cartridge 200 may be dropped into the compartment 322 of the dispensing unit 110. It may be appreciated however, that an opening may also be defined in any portion of the dispensing unit 110, as long as it serves the purpose of conveniently inserting a cartridge 200 in the compartment 322. The door 314 may include a lock 315 to restrict access to the components of the dispensing unit 110 and, in particular, to the contents of the cartridge 200. The lock may be of a standard type requiring a key or combination, and/or may require radio frequency or biometric identification or other suitable security feature to unlock and provide access to the opening 316 and the contents of the dispensing unit 110. This locking feature may be desirable for both security and child-safety considerations. Further, screen functions also may be locked and require a user-defined PIN, biometrics or other security mechanism to unlock. The patient may choose whether or not to enable the various locking functions of the dispensing unit.

The dispensing unit 110 comprises a delivery slot 318 to dispense a medication pouch 112 at the requisite time of administration. In one embodiment, delivery slot 318 may be covered by a door. In one embodiment, the dispensing unit 110 further comprises a display screen 320 suitable for communicating with the patient and providing buttons and menus for the patient to interact with the dispensing unit 110 and make selections. Information communicated to the patient may include dosage information, notification that a pouch is ready to be dispensed, alerts for missed medication, refill requirement, errors, etc. as needed. In one embodiment, the dispensing unit 110 further includes a local or remote audible, visual, and/or tactile alarm or other device for notifying the patient that a medication pouch 112 is ready to be dispensed, has been missed or that a message is on the display screen. In one embodiment, the screen 320 may be used to allow the patient to enter information, answer questions, confirm his/her identity, etc. In one embodiment, the screen 320 of the dispensing unit 110 may be used as a digital photo frame when communications on the display are not required.

In one embodiment, dispensing unit 110 also is equipped with a radio receiver, which allows a user to tune into radio stations when a medicine pouch 112 is not being dispensed.

In one embodiment, dispensing unit 110 is equipped for networking with a secured wireless network such as a home Wi-fi or cellular broadband service. In one embodiment, dispensing unit 110 is additionally or alternately equipped with a secured Ethernet connection as well as an RJ-45 jack (i.e., a telephone jack) as means of communication. A network connection enables the dispensing unit 110 to communicate with the cloud 104, as necessary, to receive information such as updates, electronic medication administration records (eMARs), schedules, and alerts provided to the cloud 104 by the patient's medicine supplier 102, physician, clinical study coordinator, etc. The dispensing unit 110 also may provide information to the cloud 104 such as adherence data, verification information, answers to questions, etc. The dispensing unit 110 may further use this communication path to send out requests for replenishment or help, or to communicate discrepancies in data (i.e., downloaded eMAR does not match patient identification) or a change in medications or schedules. In one embodiment, all data is sent and received via the cloud 104.

In one embodiment, dispensing unit 110 comprises a suitable controller or microprocessor to control the operation of various components of the dispensing unit 110 and to communicate with the medicine supplier 102, caregiver, or other appropriate individual or organization (i.e., study teams, insurance providers, etc.). Dispensing unit 110 further comprises an internal memory, such as RAM, for storing the controller's instructions and an internal or external memory for downloading and uploading required data to the cloud 104.

In one embodiment, the dispenser unit 110 has a graphical user interface (GUI), which is displayed on the screen 320 and helps a user to navigate through and select various options from the functions of the dispensing unit 110.

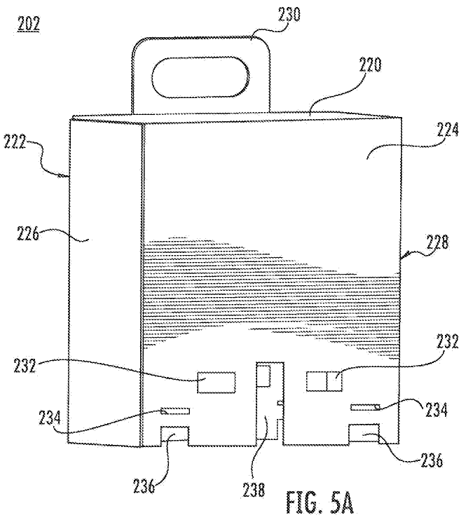

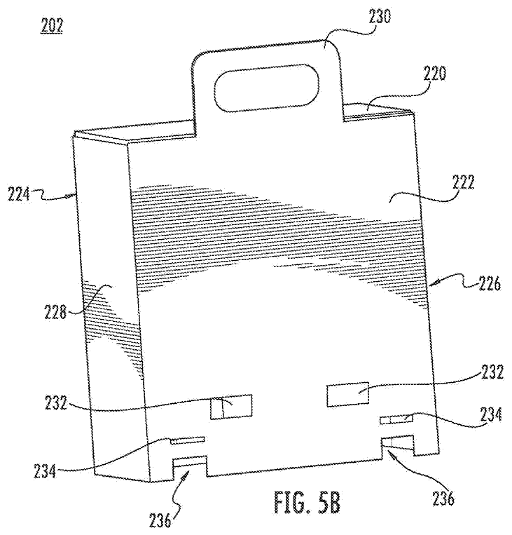

The structure and features of the cartridge components will now be described. Referring to FIGS. 3A, 3B, 5A and 5B, cartridge cover 202 comprises a top 220, sides 222, 224, front 226, and back 228. The top 220 may include a handle 230 to facilitate handling and loading of the cartridge 200 into the compartment 322 of the dispensing unit 110. In the embodiment illustrated herein, on each side 222, 224 of cover 202 are holes 232, slots 234 and recesses 236 to accommodate features of the cartridge frame 204 and will be discussed in detail later with regard to frame 204. Side 224 also includes recess 238 which accommodates a feature of the cartridge frame 204 and also will be discussed further with regard to frame 204. Other embodiments may employ different alignment/guide/retention features.

FIG. 6 illustrates an exemplary cartridge 200 with the cover 202 removed. The frame 204 is loaded with a strip 114 of medication pouches that have been rolled around the cylinder 206. In one embodiment, the cartridge frame 204 is sized and configured to fit into a dispenser unit 110 located in the patient's home.

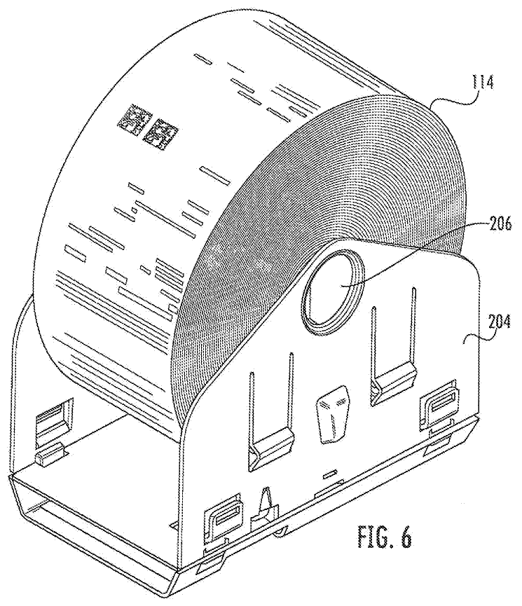

The structure of the cartridge frame 204 will now be described with reference to FIG. 7. FIG. 7 is a perspective view of the cartridge frame 204. In one embodiment, the cartridge frame 204 comprises sidewalls 208, 210, a floor 216, and a base 218 with a bottom surface 227, top surface 229, front section 217 and a back section 219, base side walls 221, 223 and base rear wall 225. In one embodiment, the frame may be made of injection moldable plastic, such polypropylene, ABS or polyethylene, for example, metal, such as steel or aluminum, for example, or a composite material, such as fiberglass or a heavy-duty cardboard, for example.

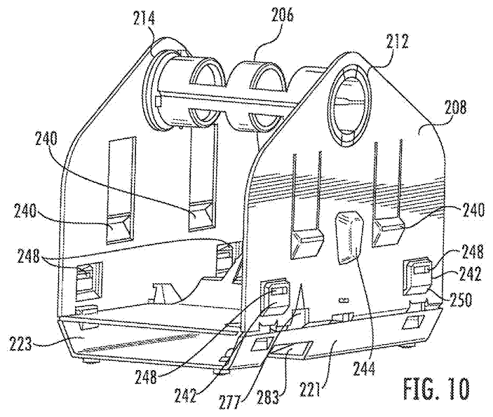

In one embodiment, the cartridge sidewalls 208, 210 are substantially pentagonal in shape, with the rectangular portion 209 of the pentagon forming the lower portion of each sidewall, below the triangular portion 211. As can be seen in FIG. 7, the rectangular portion 209 of each sidewall 208, 210 includes a variety of features which will be described now. Sidewall 208 includes a wedge 244, which is a hollow, outward protrusion from the sidewall 208. Wedge 244 is located substantially in the center of the rectangular portion of sidewall 208. Two latches 242 are present on each sidewall 208, 210 of the frame 204. Latches 242 are each a substantially square-shaped member that is separated from the sidewall on three sides, such that it protrudes slightly out of the plane of the sidewall while connected to the sidewall at the bottom of the latches 242 by an angled portion 250 (FIG. 10) of the sidewall, forming an upward-facing, flat, hook-like portion of the sidewall. Latches 242 are located near the lower edge of the rectangular portion 209 of each sidewall 208, 210. Within the face of the latch 242 is a protrusion 248 that faces back toward the sidewall 208, 210, creating a bump in the latch 242. Additionally, sidewalls 208, 210 each include two tabs 240. Tabs 240 are wedge-shaped, outward protrusions of the sidewall 208, 210, each located at the end of a strip of the sidewall 208, 210 that is disconnected laterally along its length; this allows for freedom of movement of the tabs 240 into and out of the plane of the sidewall 208, 210. Tabs 240 are located approximately in an equatorial plane of the rectangular portion 209 of the sidewall 208, 210 and are spaced equidistantly from a horizontal line in the center of the rectangular portion 209 of the sidewall 208, 210. On sidewall 208, tabs 240 are located far enough apart as to flank wedge 244. One of skill in the art will recognize that latches 242, tabs 240, and wedge 244 could be located elsewhere on the sidewalls 208, 210, provided that other features of the system with which each feature interacts are likewise relocated.

Referring back to FIGS. 5A and 5B, the cartridge cover 202 includes holes 232, slots 234 and recesses 236 and 238, which are designed to accommodate the previously discussed features of the sidewalls 208, 210. As can be seen in FIGS. 3A and 3B, and with reference to FIGS. 5A and 5B, when the cartridge cover 202 is placed over the cartridge frame 204, side 224 of cover 202 is aligned with sidewall 208 of cartridge frame 204 so that recess 238 can receive wedge 244; this allows wedge 244 to be accessible for alignment of the cartridge 200 when inserted in the dispensing unit 110, as will be discussed later. When the cover 202 and cartridge frame 204 are aligned, tabs 240 fit into holes 232 and extend outward from the cartridge 200. Slots 234 and recesses 236 accommodate latches 242: recesses 236 receive the angled portion 250 of the sidewall 208, 210 that makes up the lower portion of each latch 242, and the protrusion 248 of each latch 242 is received by its respective slot 234. The fit of the cover 202 of the frame 204 is tight enough such that the protrusions 248 “snap” into place in the slots 234 which allows the cover 202 of the cartridge 200 to fit removably but securely in place on the frame 204.

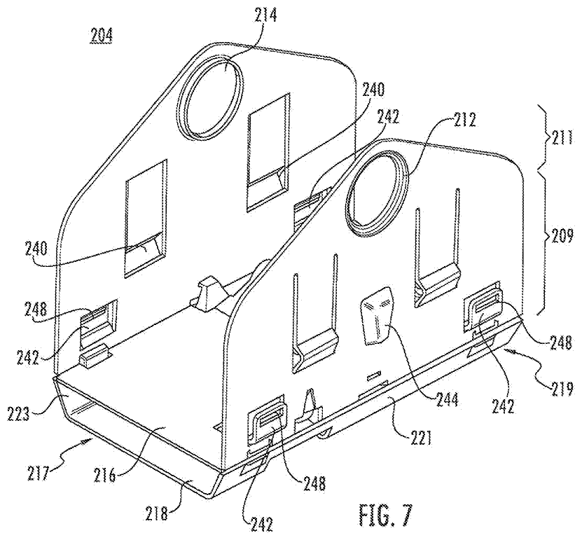

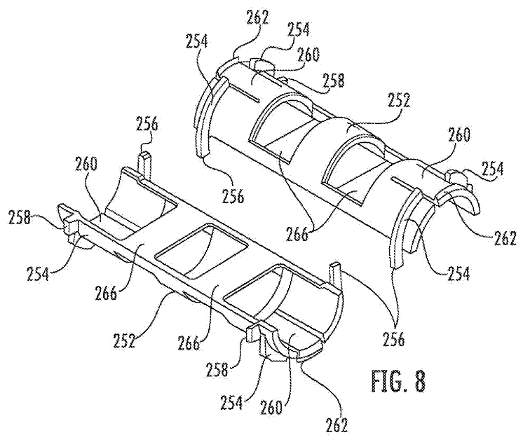

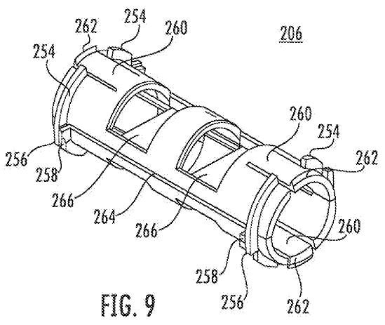

Again referring to FIG. 7, each of the triangular portions 211 of sidewalls 208, 210 includes a hole 212, 214, respectively, into which a central cylinder 206 is inserted to serve as an axle (see FIG. 8). The cylinder 206 may be made of injection-moldable plastic, such polypropylene or polyethylene, for example, metal, such as steel or aluminum, for example, or composite material, such as fiberglass or a heavy-duty cardboard, for example. FIG. 8 and FIG. 9 show that, in one embodiment, the cylinder 206 may be created by assembling two identical halves 252. Located substantially in the center at each end of each cylinder half 252 is a longitudinal tab 260. Each longitudinal tab 260 is separated from the adjacent portion of the cylinder 206 along the length of the longitudinal tab 260 and has an upturned lip 262 at its end. Extending perpendicularly to the cylinder 206 near each end and circumferentially in all regions except for the longitudinal tabs 260 is a radial ridge 254. On one longitudinal edge of the cylinder half 252, each ridge 254 extends from the cylinder 206 and ends in a small hook tab 256. On the other longitudinal edge of the cylinder half 252, aligned with the radial ridge 254 and opposite each hook tab 256, is a small receiver tab 258.

When the two halves 252 are assembled to make the complete cylinder 206 (FIG. 9), each hook tab 256 snaps onto its respective receiver tab 258 on the other half 252 to secure the halves 252 together. When the cylinder 206 is assembled, the halves are separated slightly along their length between the radial ridges 254, creating a longitudinal slot 264 along the cylinder 206. The halves 252 may be assembled around the edge of the first pouch 112 of a medication strip 114; the plates 266 secure the edge of the first pouch 112, which then extends through the slot 264, thus anchoring the strip 114 and facilitating the process of winding the strip 114 on the cylinder 206. In this instance, the “first” pouch 112, is the first pouch to be wound around the cylinder 206, as opposed to the first pouch 112 to be dispensed, which would be at the opposite end of the strip 114 and will be referenced later. The first pouch 112 to be wound around the cylinder 206 may be the last pouch 112 to be dispensed from the strip 114 or may be an empty pouch 112 or one of a series of empty pouches 112. Alternatively, a strip of paper or plastic or other suitable material may be attached to the end of the strip 114 and used for attachment of the strip 114 to the cylinder 206. The paper/plastic strip or empty pouch or pouches 112 may include notifications to the patient that the cartridge 200 is empty, refill information, pharmacy contact information, the next scheduled time for medication administration, and/or other information helpful to the patient. The medication strip 114 may then be wound around the cylinder 206 prior to insertion of the cylinder 206 into the frame holes 212, 214. U.S. Patent Publication No. 2013/0264376 describes an exemplary system that can be used to wind a strip of medication pouches into a roll and is hereby incorporated by reference in its entirety.

Loading of the strip 114 of pouches onto the cylinder 206 may be performed as the strip of pouches is produced and its contents verified for accuracy. When inserting the cylinder 206 into the holes 212, 214 of the cartridge frame 204, the cylinder tabs 260 can be displaced inwardly to facilitate the insertion process. One end of the cylinder 206 is inserted through each hole 212, 214 on the inner side of the cartridge frame 204, thereby connecting the two sidewalls 208, 210 via the cylinder 206 (FIG. 10). As the cylinder end is inserted into the holes 212, 214, the radial ridge 254 limits the distance that the cylinder 206 can pass through the holes 212, 214. Once inserted to the furthest extent allowable by the radial ridges 254, the lips 262 of the tabs 260 latch on the outer side of the respective sidewall 208, 210, thereby preventing, in concert with the radial ridges 254, lateral movement of the cylinder 206 within the cartridge frame 204. When inserted into the frame 204, the cylinder 206 acts as an independently rotating hub within the cartridge such that the medication strip 114 can be unwound as necessary during dispensing of the medication pouches 112 from the dispensing unit 110.

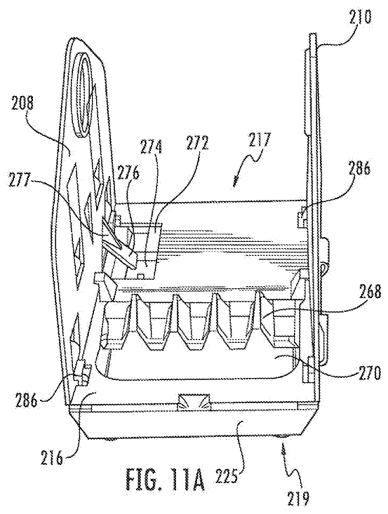

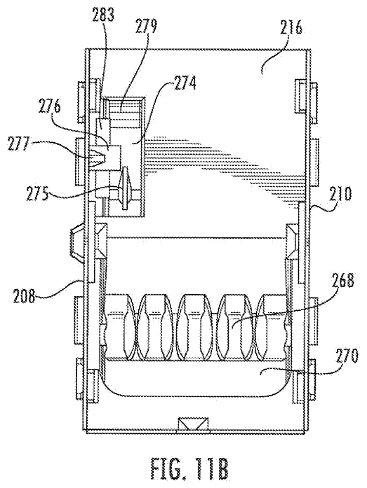

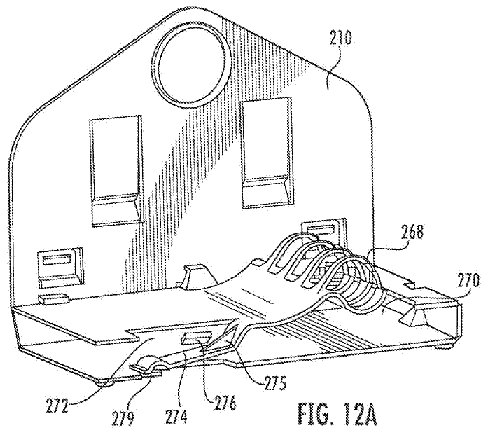

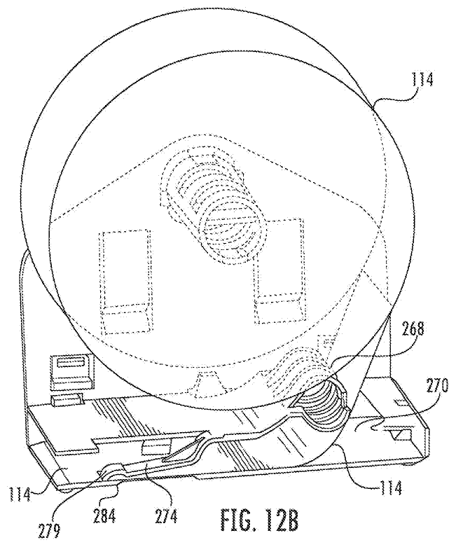

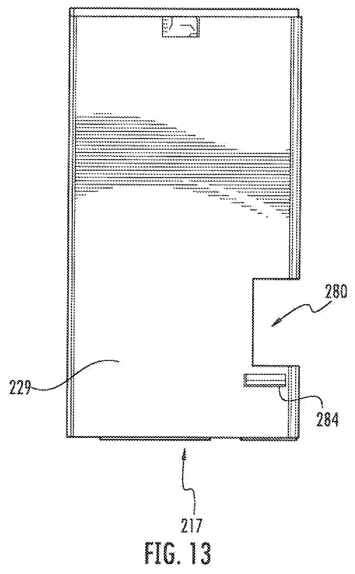

Turning now to FIGS. 11A and 11B, viewing the cartridge frame 204 from the rear, further features of the cartridge frame 204 will now be described. The floor 216 of the frame 204 contains a routing hole 270 located in the rear-most quarter of the floor 216. The hole 270 is substantially rectangular with its longer side (width) extending across most of the width of the floor 216. The width of the hole 270 is at least wide enough to accommodate the width of the medication strip 114. Along the forward-most edge of the hole 270 is a series of loops 268. In one embodiment, there are four loops 268. The outer diameter of the loops 268 may range from 0 mm to 40 mm. In one embodiment the outer diameter of the loops is in the range of 20 mm-30 mm. In one embodiment, the outer diameter of the loops is approximately 20 mm. One of skill in the art will recognize that the number and size of the loops may be varied while still maintaining functionality. A second, substantially rectangular hole 272 is located in the front 217 quadrant of the floor 216 closest to sidewall 208, with its longer edge parallel with the sidewall 208. As can be seen clearly in the cross-section view of the cartridge frame 204 shown in FIG. 12A, extending forward from the rear edge of the hole 272, adjacent the longer edge of hole 272 parallel with sidewall 208, is an arm 274 that serves as a brake member. Where the arm 274 attaches to the floor 216, the arm 274 slopes downward toward the cartridge base 218 and includes a hollow rib 275 on the top surface of arm 274 to provide more stiffness and stability to arm 274. The free end of arm 274 is arched and is positioned over a notch 284 on the upper surface 229 of base 218 (see FIG. 13). Turning back to FIGS. 11A and 11B, extending from sidewall 208 is arm 276 with hollow rib 277 on the top edge of arm 276 to stabilize arm 276. Arm 276 is positioned above the center of arm 274 and extends downwardly toward and near arm 274. The length and angle of arm 276 are such that arm 274 resides at a height approximately 12 mm or less above the upper surface 229 of base 218 when the cartridge 200 is inserted in the dispensing unit 110. FIG. 12B shows the location of a medication strip 114 when loaded on the cartridge frame 204. The medication strip 114 is loaded on the cylinder 206 so that its free end exits the roll in the direction of the rear of the cartridge frame 204 (defined by the rear section 219 of the cartridge base 218). The free end of the strip 114 is then fed through the hole 270 in the floor 216. The loops 268 provide a rounded surface past which the strip 114 can more easily move. The strip 114 is now in the space between the base 218 and the floor 216. The strip then passes under arm 274, moving toward the front of the cartridge (defined by the front section 217 of the cartridge base 218). The strip 114 remains between the base 218 and floor 216 such that it passes between notch 284 and the arch 279 of arm 274. This positioning of the strip between the notch 284 and arch 279 of arm 274 allows the strip to be held securely in place, particularly during transport. As the strip 114 follows this path it passes over hole 280.

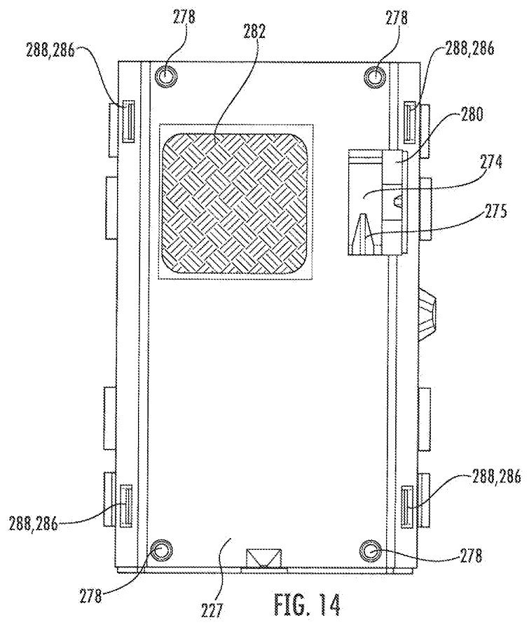

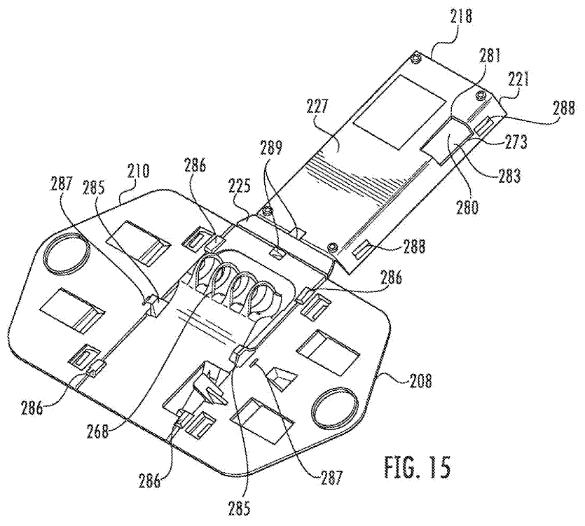

Turning now to FIGS. 13 and 14, features of the base 218 of cartridge frame 204 are illustrated. In FIG. 13, the notch 284, discussed above, on the upper surface 229 of the base 218 is illustrated. This notch 284 is positioned directly below the arch 279 in the free end of arm 274. A rectangular recess 281 in the front quadrant of base 218 adjacent sidewall 208 forms hole 280 and is positioned below hole 272 in the floor 216. Notch 284 is adjacent the forward edge of hole 280. A laterally adjacent recess in base wall 221 creates window 283 (see FIGS. 10 and 15). Viewing the base 218 from below in FIG. 14, feet 278 are positioned in each corner on the bottom surface 227 of base 218. The bottom surface 227 of base 218 may also include identifying information 282 for the cartridge 200. In one embodiment, identifying information may be provided in the form of an RFID tag. One of skill in the art will recognize that the identifying information may be provided in other suitable formats (such as bar code, for example), or in other locations on the cartridge. Identifying information that may be included in the RFID tag may include, but not be limited to, cartridge identification number, patient name, patient identification number, patient address, physician name, pharmacist name, pharmacy name, pharmacy address, prescription number(s), refill information, medical record number, cartridge fill date, cartridge expiration date, time zone information, and/or other information specific to the patient, the medication regimen, including medication administration times. In some embodiments, the identifying information may include administration times for some or all pouches 112 in the medication strip 114.

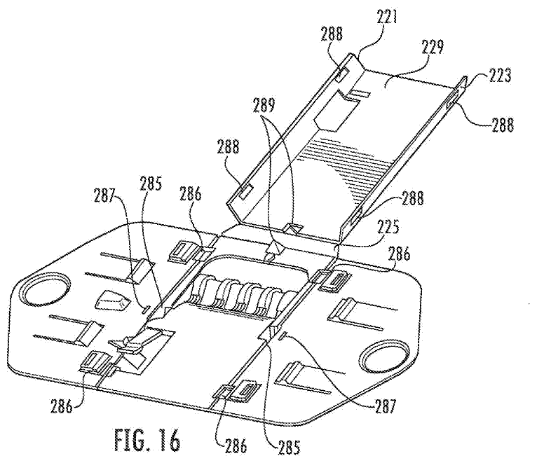

Provision of the cylinder 206 as two halves 252 can be advantageous with respect to helping to secure the medication strip 114 with the cylinder 206 for loading, as discussed elsewhere. Providing two halves 252 also may be desirable for ease of packing and shipping as the two halves 252 may be stackable and thus take up less room than the fill cylinder 206. Cartridge frame 204 also may be provided to the medicine supplier in a flat, stackable form as shown in FIGS. 15 and 16. In order to accommodate this, some features of the cartridge frame 204 are made hollow, such as the ribs 275 and 277, tabs 240, and wedge 244, as well as latches 285 and stops 289, described below. Loops 268 also facilitate stacking of the flat frame; forming this region as a solid tube or cylinder would not as easily accommodate stacking. This structure provides for ease of packing and shipping of the cartridge frame 204; this form can then be folded into the final arrangement (FIG. 7) in conjunction with loading the cartridge frame 204 with the cylinder 206 containing the medication strip 114. Referring to FIG. 15, viewing the flat cartridge 204 from the perspective of the top of the floor 216, each side 208, 210 would be folded up at 90 degree angles to the floor 216 (out of the plane of the page) and secured in place with wedge-shaped latches 285 which interlock with slots 287 in sidewall 208, 210. Similarly, base 218 folds 180 degrees underneath (into the plane of the page for FIG. 15) floor 216 by bending 90 degrees at each edge of base rear wall 225. Wedge-shaped stops 289 prevent base rear wall 225 from folding further than 90 degrees on either edge. Base 218 is secured in place by interaction of latches 286 at the bottom edges of sidewalls 208, 210 (see FIG. 16) with receiver slots 288 in each of the base side walls 221, 223.

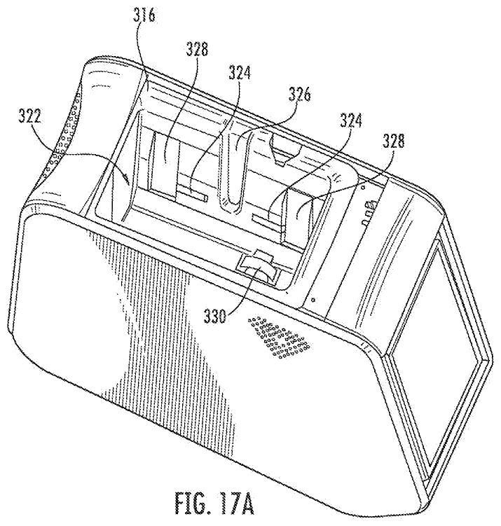

FIGS. 17A and 17B illustrate a dispensing unit 110 with the door 314 removed to reveal the opening 316 and the compartment 322 into which the cartridge 200 is inserted for dispensing of medication pouches 112 from the cartridge 200. Compartment 322 includes channel 326 (FIG. 17A) to accommodate wedge 244 of the cartridge frame 204. The singular location of channel 326 ensures that the cartridge can be loaded in one direction only and will be properly aligned within the compartment 322, with the front of the cartridge (front 217 of the cartridge base 218) facing toward the front 302 of the dispensing unit 110. Feet or pegs 278 on the bottom of cartridge frame 204 are another alignment feature; feet 278 help to properly seat the cartridge 200 in compartment 322. As can be seen in FIG. 17C, a channel 332 or receiving hole runs across the width of the front of the floor of the compartment 322. The two feet 278 located in the front 217 of the base 218 of the cartridge 204 are seated into the channel 332. Thus, the alignment features, feet 278 and wedge 244, ensure that the cartridge 200 is positioned correctly within the compartment 322 so that the medication pouches can be properly dispensed, as will be discussed further below. As can be seen in both FIGS. 17A and 17B, compartment 322 also includes slots 324 on both sides of the compartment 322. Tabs 240 on the frame 204, which protrude through holes 232 of the cover 202, are received in slots 324 and removably snap into place to secure the cartridge 200 in position for dispensing. Two channels 328 on each side of compartment 322 also are provided to accommodate the protrusion of latches 242 of the cartridge 200. As discussed above, in other embodiments the cartridge and compartment may include other features that retain the cartridge in place.

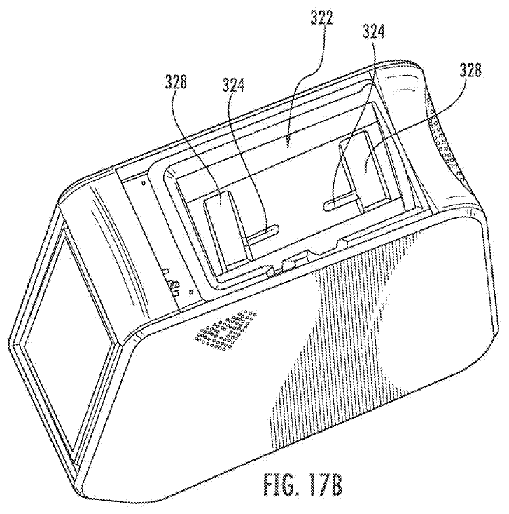

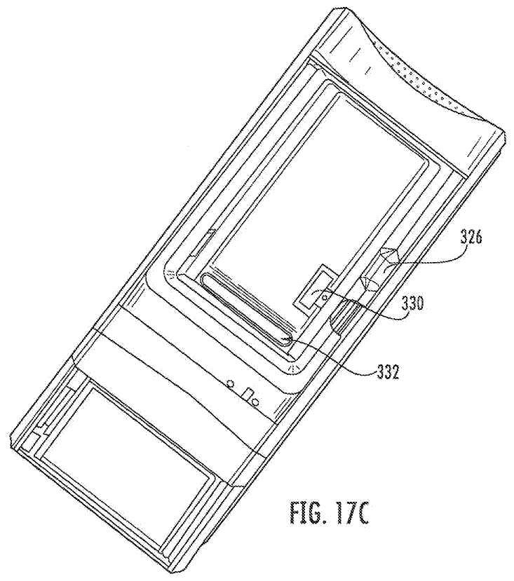

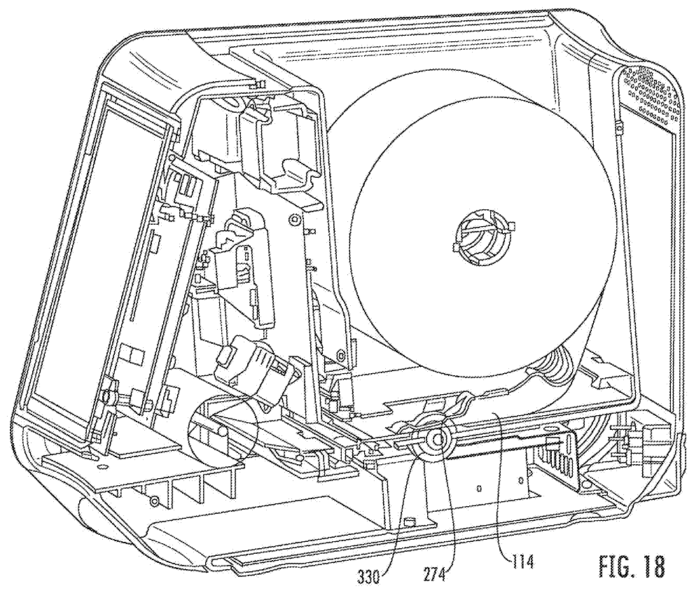

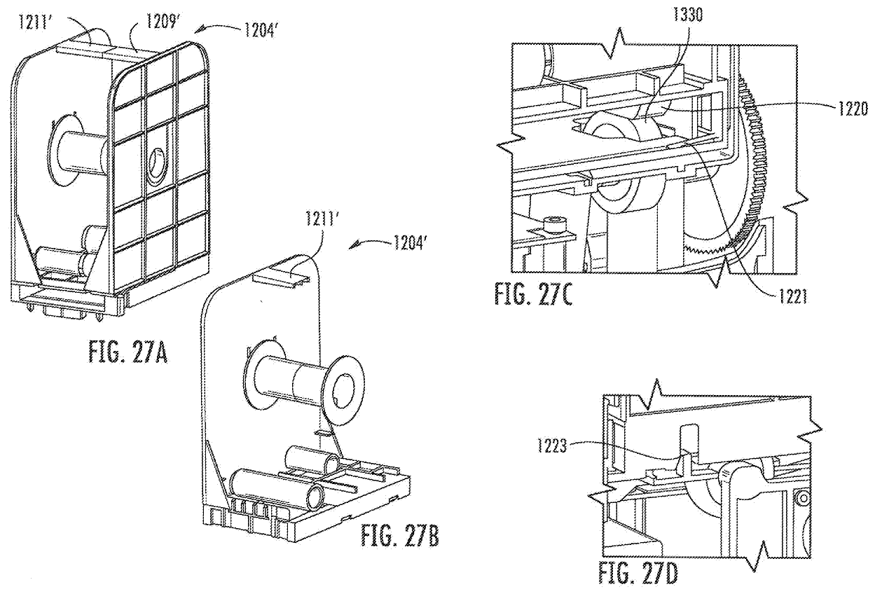

Additionally, the dispensing unit 110 contains a roller 330 or other drive unit that extends into the compartment 322. When a cartridge 200 is properly loaded into the compartment 322, roller 330 is positioned in line with hole 280, along its lateral edge adjacent sidewall 208, directly opposed to arm 274 (in other embodiments, a hard stop may be employed instead—see FIG. 27C at 1220). FIG. 18 shows a cross-section of the dispensing unit 110 with a cartridge 200 loaded in compartment 322. Roller 330 extends through hole 280, contacting the strip 114 along its side seam and pressing it against arm 274 such that, when it is time to dispense a pouch 112, roller 330 is able to move strip 114 forward through frictional interaction with the pouch 112 against arm 274. Arm 276 provides resistance to the pressure of roller 330 against arm 274 by limiting the ability of arm 274 to move away from the roller 330.

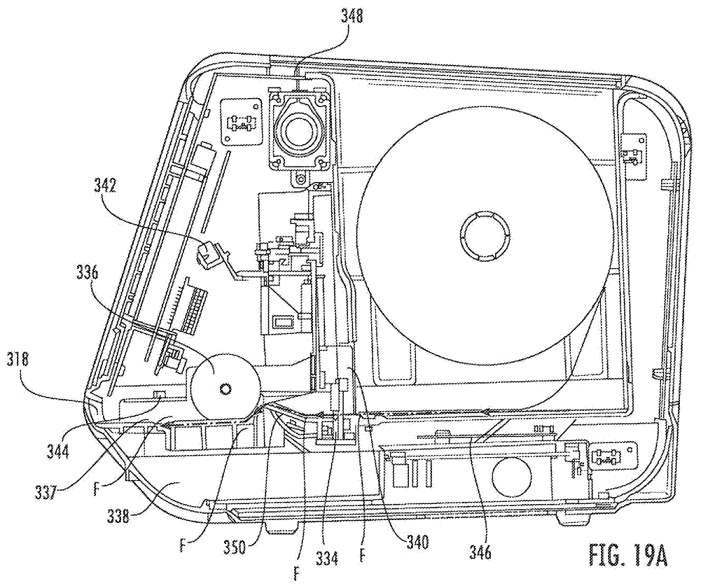

FIGS. 19A and 19B illustrate further detail of the dispensing unit 110 relative to movement of the medication strip 114 and pouches 112; some components, not relevant to this discussion, have been removed for clarity. As can be seen in FIG. 19A, the forward (dispensing) path F of the medication strip 114 continues past a cutting mechanism 334 (i.e., scissors, blade, etc.) and sensor 340. The sensor 340 detects a perforation or seam 116 between pouches so that cutting mechanism 334 can cut and separate the forward-most pouch 112 at the appropriate time, as will be detailed later. Sensor 340 may be a redundant sensor (more than one sensor closely spaced) to ensure detection of the seam 116 and cutting of the pouches 112 in the correct location. As the medication strip 114 moves forward, it moves along ramp 350 and is engaged by roller 336 which helps to pull the strip 114 forward. Roller 336, as well as roller 330, may be made of a type of foam, such as urethane, for example, or other sufficiently soft material so that the medications within the pouches 112 are not crushed or otherwise damaged as the pouches are moved by the rollers 330, 336 in the dispensing process. When positioned on the edge of hole 280 and only contacting the pouch 112 side seam, roller 330 may be made of a harder material such as rubber or plastic, since it does not come in contact with the medication. When a pouch 112 is paused in the forward path F such that the following perforation or seam 116 is placed in position to be cut by the cutting mechanism 334, sensor 342 may view the bar code 120 on the medication pouch 112 to confirm that the correct pouch 112 is in position to be dispensed. Once pouch 112 is confirmed and the perforation or seam 116 has been cut, the released pouch 112 is moved forward by roller 336 onto staging platform 337. Sensor 344 is positioned to detect if a pouch is present on the platform 337. When dispensing of the pouch 112 is requested by the patient, roller 336 can move the pouch 112 through the slot 318 to be retrieved by the patient. One of skill in the art will recognize that sensors, 340, 342, and 344 may be LED, camera or any other type of sensor appropriate for detecting the events and for the environment. The dispensing unit 110 may also include door lock sensor 348 and cartridge identifier 282 sensor 346 (i.e., RFID reader, bar coder reader, camera, etc., as appropriate for identifier 282 on cartridge 204).

FIG. 19B illustrates the path R of the pouch 112 under certain circumstances, such as when the wrong pouch 112 is in position for dispensing or the patient does not retrieve the pouch 112 during the allowed administration window. Under these circumstances, roller 336 may operate in reverse and move pouch 112 along path R. Due to the upwardly sloping geometry of ramp 350, when the pouch 112 is moved rearwardly by the reverse movement of roller 336, the pouch 112 slides under the ramp 350 and falls into exception tray 338. Tray 338 may include a locking mechanism (not shown) for security and child-safety purposes, but may be opened by appropriate individuals to access medication pouches 112 contained therein. Some embodiments may lack an exception tray altogether.

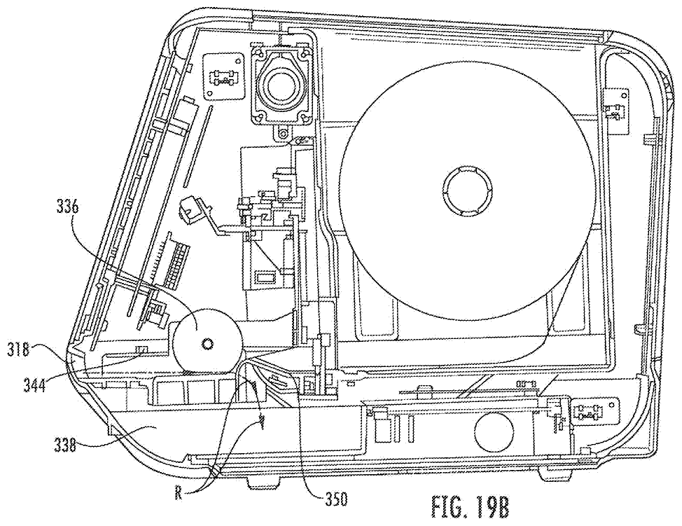

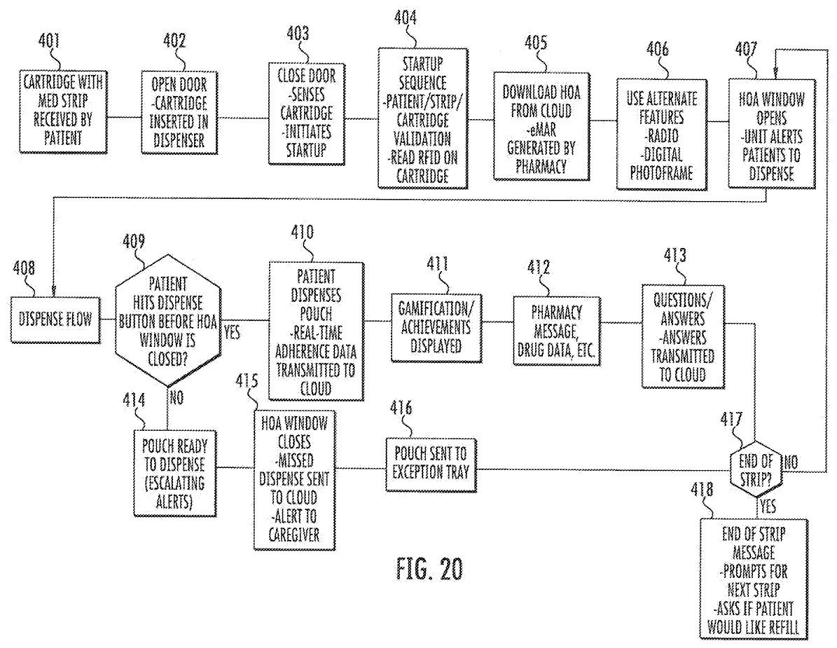

FIG. 20 is a flowchart illustrating the operation of the dispensing unit to automatically dispense a medicine pouch at a requisite and predetermined time. Referring to FIG. 20, firstly in step 401 a cartridge frame is loaded with a strip of medicine pouches covered with the cartridge cover and delivered to the patient/customer. The customer opens the door of the dispensing unit in step 402, drops the cartridge into the dispensing unit and closes the door in step 403. The controller in the dispensing unit senses the cartridge by means of a suitable sensor and initiates a startup sequence. The startup sequence, in one embodiment, comprises validation of the patient, medicine strip and the cartridge, as shown in step 404. Through appropriate sensors in the dispensing unit, information about the cartridge and medications contained therein is read from the identifier on the cartridge (i.e., bar code, RFID, etc.). The dispensing unit itself may be patient agnostic; that is, the dispensing unit may not be assigned to a particular patient or waiting for a certain cartridge. The specifics of the medication regimen for that patient may be determined when the cartridge is inserted into the dispensing unit. When the information of the identifier on the cartridge is read, the controller of the dispensing unit may require validation of the patient's identity in step 404 to confirm that the correct medications have been received for the correct patient. The controller may employ a user-specific PIN, RFID identification, biometric or other appropriate identifying data for patient validation. The controller may communicate information about the patient and cartridge to the cloud and patient-specific information retained by the cloud may then be downloaded to the dispensing unit. The electronic medication administration record (eMAR) for that patient, which includes medication administration times (hour of administration, or HOA), is created by the pharmacist and maintained in the cloud for access by the dispensing unit. When the eMAR is downloaded in step 405, the controller of the dispensing unit contains the schedule for dispensing the mediation pouches to the patient. Access to the cloud also provides a means of data recovery if the data collected from the identifier is determined to be incomplete or invalid.

When the dispensing unit is inactive (in terms of dispensing medication) other features may be used such as the radio or digital photo frame features of the dispensing unit, as in step 406. Other options include webcams, Bluetooth devices, and the like.

When the time for administration of the first medication pouch arrives, the dispensing unit issues an alert to the patient in step 407. Alerts may consist of any appropriate means of notifying the patient of availability of the medication and may include, but not be limited to, audible alerts such as bells, buzzers, chimes, etc.; tactile alerts such as vibration; visual alerts such as flashing lights which may be on the unit, on a device carried by the patient, including cell phone, smart phone, MP3 player or other mobile device, or may be through control of the room lighting; text alerts; email alerts, phone calls or the like. The eMAR may include information defining a time period within which each medication dose may be administered (the HOA window). During the HOA window, the patient is able to dispense the appropriate medication pouch; once the HOA window expires (the time period for administration of that medication dose has been exceeded) the patient will no longer be able to dispense the pouch through the usual path. With the opening of the HOA window, the medication pouch is made accessible within the dispensing unit in step 408. When the patient is ready to dispense the medication pouch and if the time is still within the HOA window, the patient selects the dispense button on the dispensing unit screen in step 409. In step 410, the medication pouch is dispensed to the patient and adherence data is transmitted to the cloud in real time, reporting that the patient's medication was taken. In one embodiment, the dispensing unit may display achievements or provide a game (i.e., health-related game, game related to adherence progress, etc.) to the patient in step 411. In one embodiment, in step 412 the dispensing unit may display promotional or informational messages, such as information about the drug or a message for the patient, which has been configured in the cloud by the pharmacy, physician, clinical study coordinators, etc. In one embodiment, a series of questions for the patient may be configured in and delivered from the cloud, with the patient's answers being delivered back to the cloud in step 413. This may be particularly useful for clinical studies or questions from the patient's physician relative to side effects of the medications and/or the patient's general health. Steps 411, 412, and 413 are not all required and are not mutually exclusive; any or all of these steps may be utilized with the dispensing unit.

Alternatively, if the patient does not dispense the medication pouch when the HOA window opens, the dispensing unit may provide additional alerts of escalating frequency and urgency to remind the patient that the pouch is ready to dispense, as in step 419. Escalating alerts may include, but not be limited to, louder audible alerts, changes in the sound or pattern of audible alerts, increased strength and length of tactile alerts, brighter or faster flashing lights, increased frequency of texts, emails, phone calls, etc. If the patient does not select the dispense button before the HOA window expires, information may be sent to the cloud in step 415 indicating that the patient has missed the medication administration event and an alert may be sent to an appropriate individual such as a caregiver, pharmacist, physician, family member, etc. In step 416, if an exception tray is included, the missed pouch is moved to the exception tray to remove it from the dispensing path. The pouches in the exception tray can still be accessed. In one embodiment, access to the exception tray may be limited to a caregiver in cases where it is not advisable to allow the patient access to the medications. A sensor in the dispensing unit may monitor contents of the exception tray and notify the patient or other individual when the tray is full. If the tray becomes full, the dispensing unit may stop dispensing until the tray has been emptied or at least enough pouches have been removed so that it is no longer full.

At decision point 417, sensors of conventional construction determine if the end of the medication strip has been reached. If sensors determine that the end of the medication strip has not been reached, then a new HOA window will open at the appropriate time and the process will move back to step 407. If the end of the medication strip is sensed, the dispensing unit will not open an HOA window and flow will move to step 418 where a message is delivered to the patient that the end of the strip has been reached and prompting the patient to remove the empty cartridge and load a new one. The system may also ask the patient if they would like to order another refill cartridge to have on hand and may submit refill requests automatically through the cloud to the medicine supplier. In one embodiment, the status of all the events generated at the dispensing unit, such as alarms, refill requests, and dispensing activity indicators may be uploaded to the cloud.

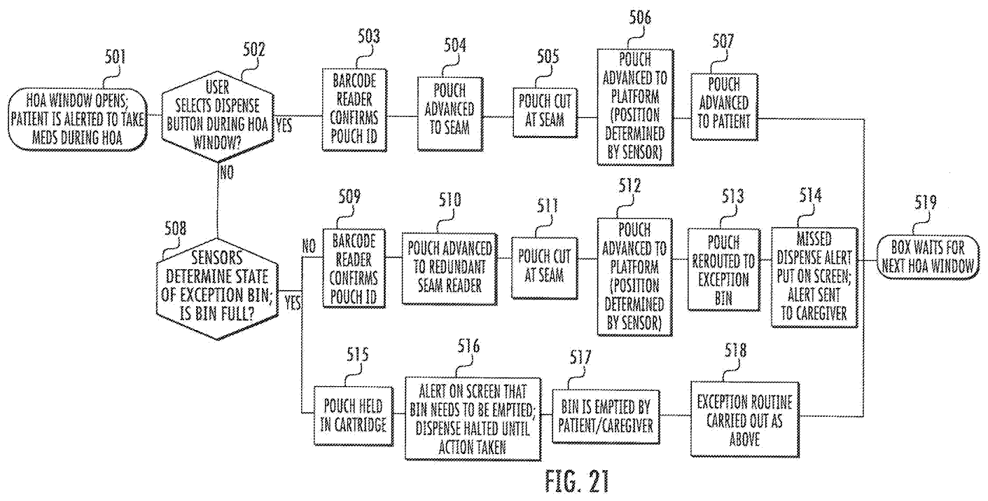

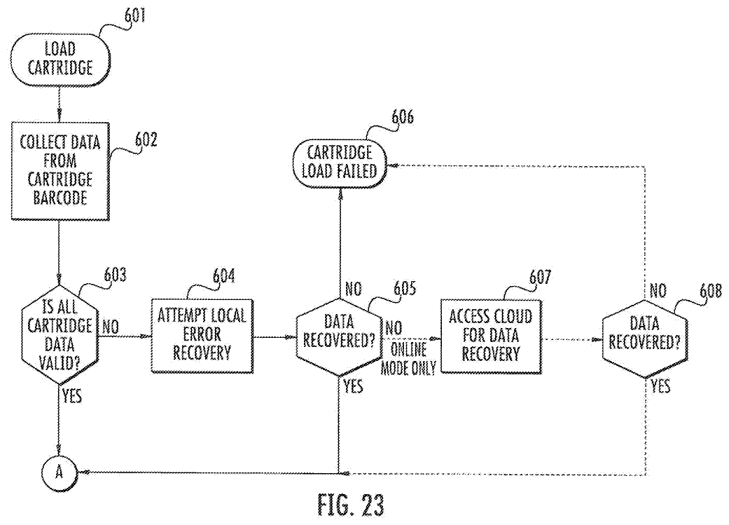

FIG. 21 illustrates an exemplary mechanical flow of the dispensing unit during the operation of the unit. At step 501, the HOA window opens and the patient is alerted to dispense a medication pouch, as in step 407 of FIG. 20. At decision point 502, the unit determines if the user has selected the button to dispense the medication pouch. If the user selects the dispense button during the HOA window, at step 503 a sensor confirms the identification of the first pouch in the strip by reading the bar code, RFID tag, etc. If the data collected at this step is determined to be invalid or incomplete, the system may access the cloud to retrieve the relevant information (see FIG. 23, dashed lines). Alternatively, the system may attempt error recovery using approaches discussed below. At step 504 the pouch is then advanced past a sensor that identifies the location across which to cut the pouch strip in order to separate the first pouch from the remainder of the strip. A perforation may be provided within the seam between the pouches and the cut may occur at or near the perforation, but at least within the seam. The strip is cut at step 505 and the pouch is advanced to a platform within the dispensing unit at step 506 and moved forward through the dispensing slot to be dispensed to the patient at step 507. The system then waits for the next HOA window at step 519.

In one embodiment, one or more cameras are used for the sensors and a computer vison subsystem may use one or more pouch features (including but not limited to the registration symbols, barcode regions, pouch seams, physical material characteristics) in the pouch detection and evaluation process. This process can identify various aspects of the pouch and enable system functionality, including but not limited to seam detection discussed above, reading of bar code information, and counting and indexing of pouches as they are removed from the cartridge.

If the patient does not select the dispense button during the HOA window at step 502, if an exception tray is present, the process moves to decision point 508 and the sensor monitoring the status of the exception tray (also called the exception bin) determines if the tray is full. If the sensor determines that the bin is not full, at step 509 a sensor confirms the identification of the first pouch in the strip by reading the bar code, RFID tag, etc. At step 510, the pouch is advanced past a sensor that identifies the location across which to cut the pouch strip in order to separate the first pouch from the remainder of the strip. The strip is cut at step 511 and the pouch is then advanced to a platform within the dispensing unit at step 512. At this point, the pouch is rerouted at step 513 to move it to the exception tray. A missed dispense alert may be shown on the display screen of the dispensing unit at step 514 and an alert may be sent to an appropriate individual such as a caregiver, physician, family member, etc. The system then waits for the next HOA window at step 519.

At decision point 508, if the sensor determines that the exception tray is full, the pouch remains attached to the medication strip at step 515. An alert is provided at step 516 notifying the user that the tray must be emptied and dispensing is halted until further action is taken to empty the tray. The alert may take any form, as described above for other alerts of the system, as appropriate to notify the user, and may be made distinguishable from other types of alerts of the system. At step 517, the bin is emptied and at step 518 the system progresses to the exception routine (steps 509 through 514). After completion of the exception routine, the system resumes normal operation and waits for the next HOA window at step 519. Alternatively, a “full” determination at step 508 may trigger a visual alert that a medication was missed.

FIGS. 23-25 illustrate steps in the cartridge loading and pouch dispensing processes of the dispensing unit. With the exception of steps specific to online mode operation (which are shown with dashed arrows in FIG. 23), the steps described here can be used in an offline mode, which may be used when there is not access to the cloud to obtain the necessary information for dispensing. Referring to FIG. 23, at step 601, the cartridge is loaded in the dispensing unit and at step 602 the unit may scan and collect data from the cartridge barcode (or RFID tag, as appropriate). The data collected may include, but may not be limited to, schedule information pertaining to administration times for the pouches in the strip; patient name; patient ID; cartridge ID; prescription numbers; the date the cartridge was filled with the medication strip; time zone information; any other information required and/or desirable to identify the patient, the medications in the cartridge, and the dispensing schedule, and any information required and/or desirable to properly dispense medication from the cartridge to the patient at the appropriate time without requiring access to the cloud. At step 603, the system may evaluate if all cartridge data is valid. If the barcode or RFID information is damaged or otherwise unreadable making the data invalid, the system may attempt error recovery at step 604. It is well known in the art that 2D Data Matrix barcodes incorporate duplicated data encoded in and distributed throughout the barcode image. This duplication of data provides the potential for data to be reconstructed from one part of the barcode if the data in another part of the barcode is damaged. The system may make a determination at step 605 as to whether the data has been recovered—depending upon the level of damage done to the code, the data may or may not be recoverable. If the data cannot be recovered, the cartridge load process fails (step 606); in this case the unit may display a message to the user indicating that the medication cannot be dispensed. The unit also may provide additional guidance such as: a recommendation to the user to contact their pharmacist or another individual who can address the issue; a notification that the medication can be dispensed manually until the dispensing issues are addressed; notification of the time to manually dispense a pouch; the appropriate pouch identification number for each administration time for manual dispensing, instructions on how to manually dispense the pouches; contact information for the pharmacist or other individual to contact; an option for the patient to request a call-back from the pharmacy; etc. The unit also may still provide alerts to the user at the appropriate medication administration times.

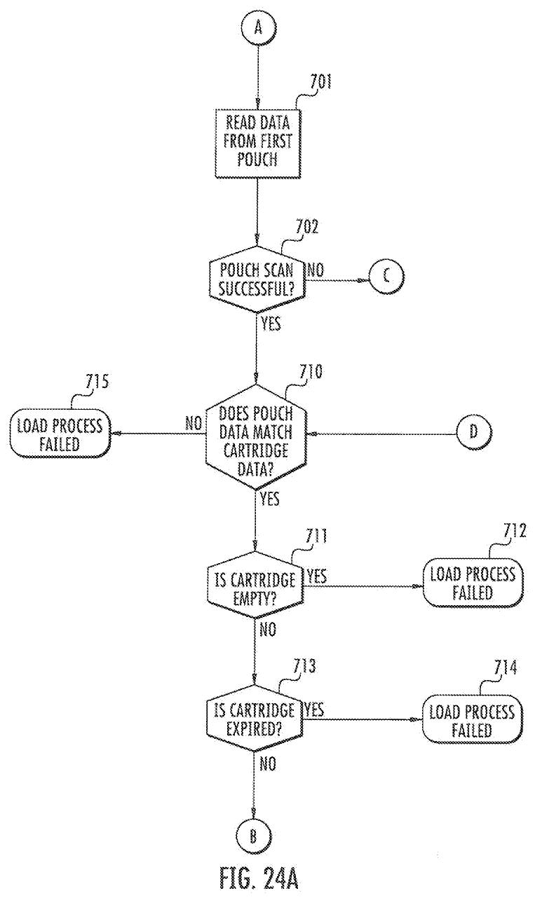

Turning briefly to the online mode (dashed lines in FIG. 23), if the data is not recovered at step 605 and the system is online, the system may access the cloud at step 607 to recover the necessary information. At step 608, the system again evaluates whether the data has been recovered. If the data has not been recovered from the cloud, the cartridge load process fails (step 606) and the unit may provide messages, guidance, alerts, etc., as described above. If the data has been recovered, the system may move to the steps identified in FIGS. 24A and 24B, as described below.

If the cartridge data is determined to be valid at step 603, or if the system determines at step 605 or step 608 that the data has been recovered, the system may move to the steps identified in FIGS. 24A and 24B. At step 701 (FIG. 24A), the system may scan and read the data from the barcode (or RFID or other identifier, as applicable) on the first pouch in the strip. At step 702, the system may evaluate if all pouch data is valid. If the information obtained from the scan is damaged or otherwise unreadable, the system may attempt error recovery at step 703 (FIG. 24B). The system may attempt to utilize the built-in error correction of the barcode, as discussed above with respect to the cartridge identifier/barcode. Alternatively or in addition, the system may read a second, duplicate bar code located in another area of the pouch to determine if the data contained there is valid. At step 704, the system may evaluate if the pouch data has been recovered as a result of the local error recovery process. If all data has not been recovered, the system may attempt data recovery using data obtained from the next pouch, at step 705. If the data can be more easily read from the neighboring pouch, the information can be extrapolated to the first pouch—the system can determine the number of the first pouch as well as the administration time (using information obtained about the schedule from the cartridge barcode). The system may again determine at step 706 if the data for the first pouch has been recovered. If the data has not been recovered, the system may check the pouch index at step 707 and, by identifying the pouch number, may retrieve schedule information from the cartridge data. By keeping an accurate count of the pouches, the system always knows the sequence of the pouches in the administration schedule. The system may again determine at step 708 if the data has been recovered. If the data cannot be recovered, the pouch read process fails at step 709. The unit may display a message to the user indicating that the medication cannot be dispensed. The unit also may provide additional guidance such as: a recommendation to the user to contact their pharmacist or another individual who can address the issue; contact information for the pharmacist or other individual to contact; an option for the patient to request a call-back from the pharmacy; etc.

If the pouch barcode scan is successful at step 702, or if the data can be successfully recovered at any of steps 704, 706, or 708, the system may proceed to step 710 where it evaluates if the data acquired from the pouch matches the data acquired from the cartridge. Some of the information provided in the pouch barcode (such as, for example, patient identification, cartridge identification, prescription numbers, etc.) can be redundant to the information provided in the cartridge barcode, allowing for this validation step. This verification process ensures that the correct cartridge was used to load the correct strip of medications and does not allow the dispensing to proceed based only on the cartridge information. If the matching is successful at step 710, the system may proceed to step 711 where it makes a determination as to whether the cartridge is empty. If the cartridge is determined to be empty, the load process fails at step 712 and the system may provide one or more messages to the user such as, for example: notification that a new cartridge must be loaded; instructions on how to load a cartridge; identification of the next cartridge to be loaded; instruction to contact the pharmacy to order a new cartridge; contact information for the pharmacy; an option for the patient to request a call-back from the pharmacy; etc. If the cartridge is not empty, the system may proceed to step 713 and make a determination as to whether the cartridge has expired. If the cartridge has expired, the load process fails at step 714. The user may be notified of the failure and instructed to load a new cartridge or contact the pharmacy to obtain a new cartridge. The system also may provide additional information to the user such as, for example: instructions on how to load a cartridge; identification of the next cartridge to be loaded; contact information for the pharmacy; an option for the patient to request a call-back from the pharmacy; etc. Referring back to step 710, if the pouch data and cartridge data do not match, the load process fails at step 715. The system may display a message to the user such as, for example: instruction to contact the pharmacy; contact information for the pharmacy; an option for the patient to request a call-back from the pharmacy.

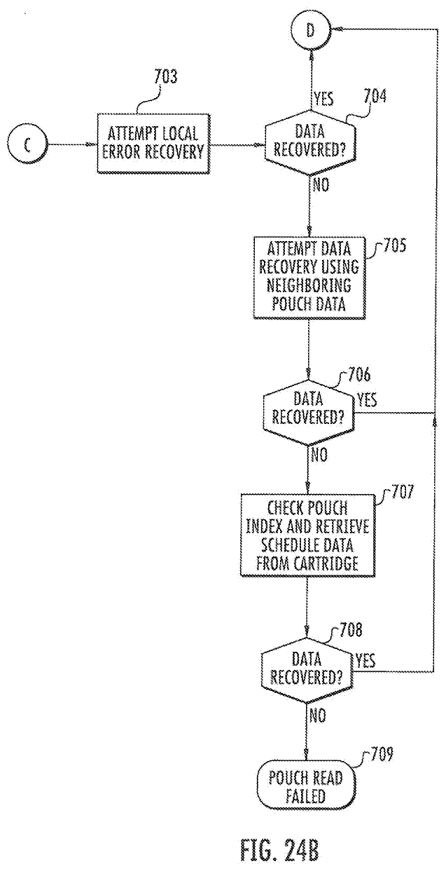

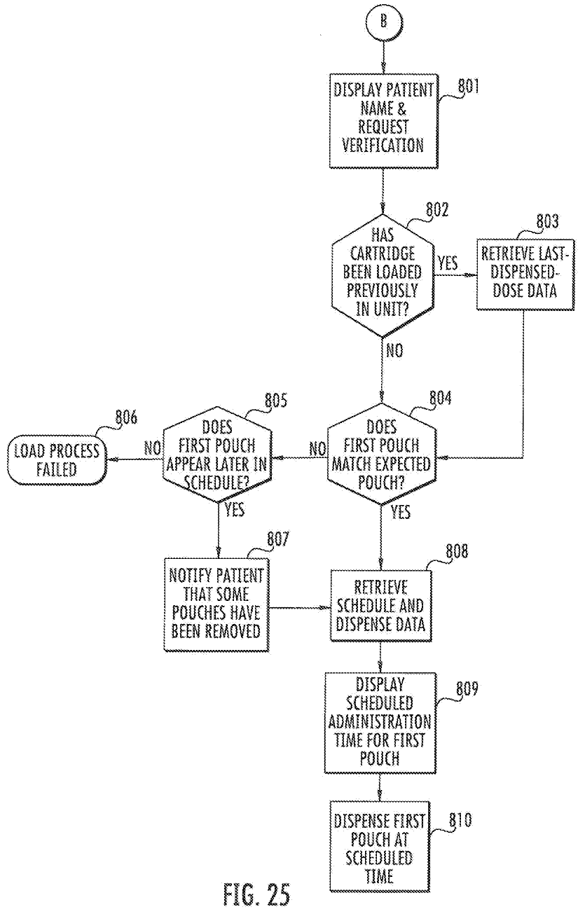

If the system determines that the cartridge is not expired at step 713, the process moves to FIG. 25. At step 801, the system may display the patient name for the loaded cartridge and request verification from the user. When the user verifies that he/she is the correct patient for that cartridge, the system may determine at step 802 if the loaded cartridge has been previously loaded in that unit. Some circumstances, for example, regarding when a cartridge may have previously been used in the unit may include: 1) a patient uses multiple units to dispense their medication; for example, the patient might use one unit at home and another unit at a family member's house, thereby moving the cartridge back and forth between units when they travel; 2) one unit may serve several patients in the same household; in this case there may be situations where patient #1 removes their cartridge and patient #2 inserts theirs, and vice versa; 3) some patients may remove their cartridge from the unit in order to manually dispense one or more pouches from the cartridge to take with them if they will be away from the unit for the day or for an extended period of time. Under circumstances where a cartridge is reinserted in a unit in which it has previously been used, the system knows which pouches have been dispensed and which pouch to expect next. If the system determines at step 802, that the cartridge has been previously used in that unit, the system may proceed to step 803 to retrieve information regarding the last medication pouch that was dispensed from that cartridge. Once the system retrieves this information, or if it determines at step 802 that it is a new cartridge, the system may evaluate if the first pouch in the strip is the pouch that it expects, at step 804; this expectation may be based on the retrieved data regarding the last pouch dispensed, if the cartridge is a previously used cartridge, or it may be the expected first pouch in a strip, if it is a new cartridge. In either situation, the system may use the data acquired from the cartridge barcode and pouch barcode to make this determination. If the system determines that the first pouch is not the expected pouch, it may then assess, at step 805, whether the first available pouch appears later in the dispensing schedule for that cartridge. If the pouch does not appear later in the schedule, the load process fails at step 806. The system may display a message to the user such as, for example: instruction to contact the pharmacy; contact information for the pharmacy; an option for the patient to request a call-back from the pharmacy. If the system determines, at step 805, that the first pouch is to be dispensed later in the schedule, the system may notify the user, at step 807, that some pouches have been removed from the cartridge. If the first pouch is the expected pouch (step 804) or appears later on the dispensing schedule (step 807), the system may then move to step 808, retrieving the schedule and dispensing data. This information may be used to display to the user the scheduled administration time for the first pouch in the strip (step 809), which will then be dispensed at the scheduled time (step 810).

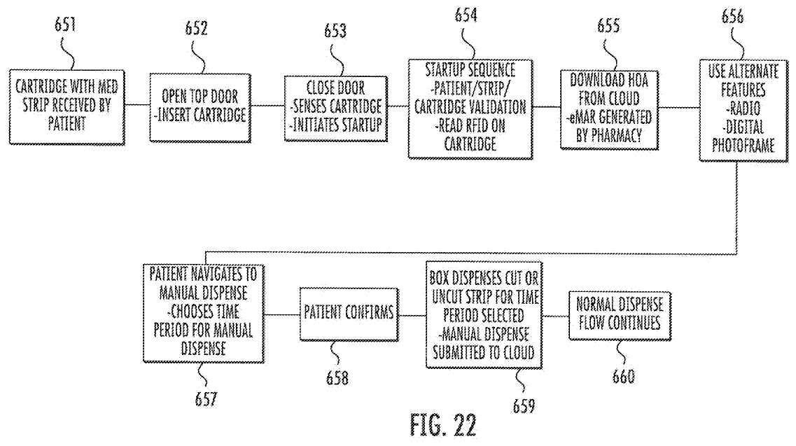

One of skill in the art will recognize that not all of the steps enumerated above need necessarily occur in the order in which they are described here. As nonlimiting examples, the system may first collect data from the first pouch and then from the cartridge, or it may collect the data from each source simultaneously; the system may make a determination on whether the cartridge is new or has been previously loaded in the unit prior to determining whether the cartridge is empty or expired. One of skill in the art will also recognize that many of the same steps may be performed in the cartridge loading and dispensing process regardless of whether the information is obtained from the cloud or offline but that the collection of data from the barcodes, in particular, provides the local information to enable offline dispensing. Additionally, one of skill in the art will recognize that, while these steps are discussed with respect to the “first” pouch, this process occurs for each pouch in the strip as it becomes the first pouch in the roll (i.e., next pouch to be dispensed), not only for the first pouch in a new cartridge. In one embodiment, the dispensing unit of the present specification also provides a user with an option of “Manual dispense”. When this option is selected, medicine pouches can be dispensed outside the designated HOA; this may be desirable if the patient is traveling or has other reason to be away from the dispensing unit during one or more HOA events. FIG. 22 is a flowchart illustrating an exemplary process flow to carry out the manual dispense option. Referring to FIG. 22, steps 651 to 656 are identical to steps 401 to 406 of FIG. 20. At step 657 the patient selects a manual dispense option provided in a menu on the display screen of the dispensing unit. When choosing the manual dispense option, the patient is able to select the time period for which he wishes to manually dispense medication pouches. In one embodiment, the user may select a time period—such as 1 day or 2 days—for which they want the medication. The user may instead select a number of pouches, such as 2 or 3. The user may select as few or as many pouches as needed within a certain range; a limit may be set on the total number of pouches to be dispensed manually without consultation with the patient's physician, pharmacist, etc. The GUI of the dispensing unit prompts the user for a confirmation of the manual dispense and time period or number of pouches selected, as shown in step 658. On receiving a confirmation from the patient, the dispensing unit dispenses a cut or uncut strip (as desired) consisting of the appropriate pouches for the selected timeframe and an update about the manual dispense is then submitted to the cloud, as shown in step 659. At step 660, normal dispensing flow continues, accounting the for the appropriate HOA events covered by the manual dispensing activity.

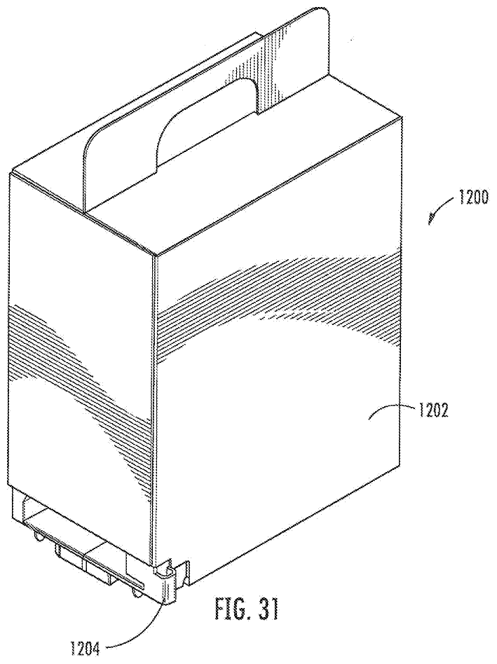

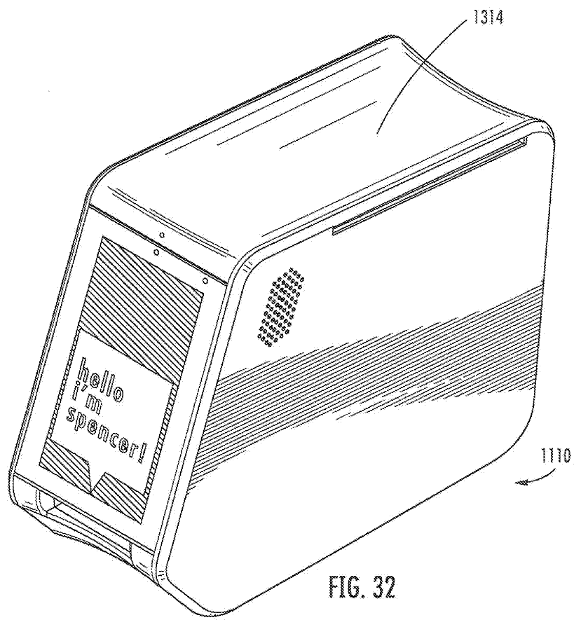

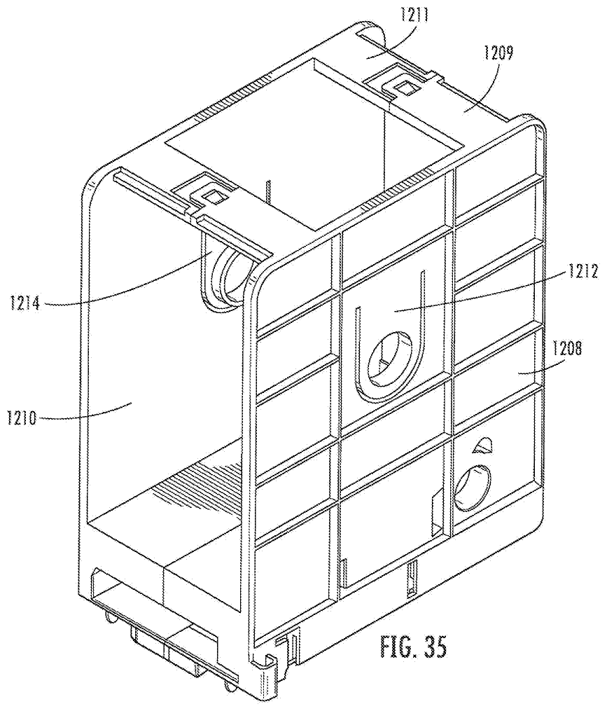

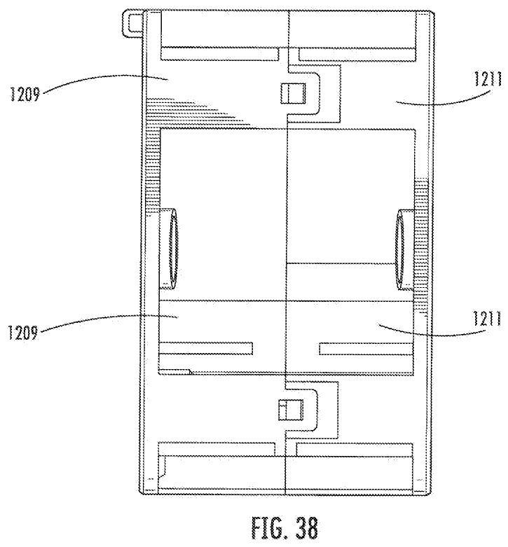

Referring now to FIGS. 31-41, another dispenser unit, designated broadly at 1110, is illustrated therein (and shown in full in FIG. 32). Many of the components of the dispenser unit 1110 and the cartridge 1200 residing therein are the same as or similar to those of the dispenser unit 110 in operation and function. Some of the differences in the dispenser units 110, 1110 and the cartridges 200, 1200 are discussed below.

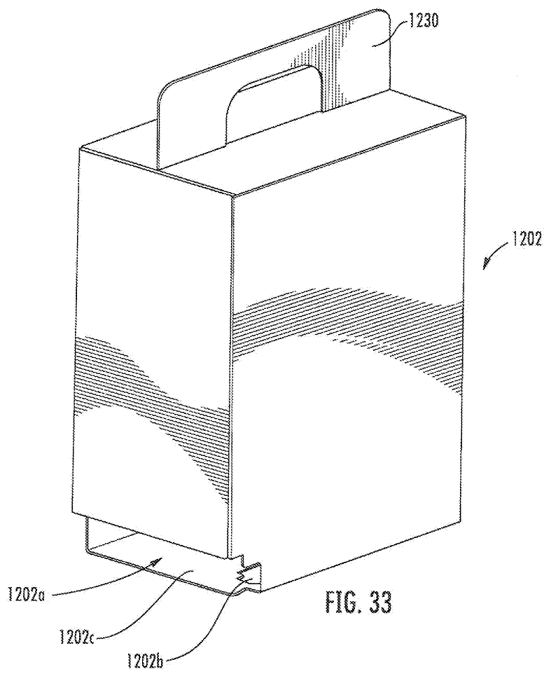

Referring first to FIG. 33, a cartridge cover 1202 of the cartridge 1200 is illustrated therein. The cover 1202 includes is generally rectangular, and includes a dispensing window 1202a in its lower front edge. A handle 1230 projects from the center of the top 1220 of the cover 1202. The cover 1202 also includes a hole 1202b in the floor 1202c. In some embodiments, the cover 1202 is formed of cardboard, and is typically constructed by folding a single flat blank of cardboard into a rectangular box. As can be seen in FIG. 31, the cover 1202 overlies a cartridge frame 1204 (discussed in more detail below); the combination of the cover 1202 and the cartridge frame 1204 comprise the cartridge 1200 that is loaded into the dispenser 1110.

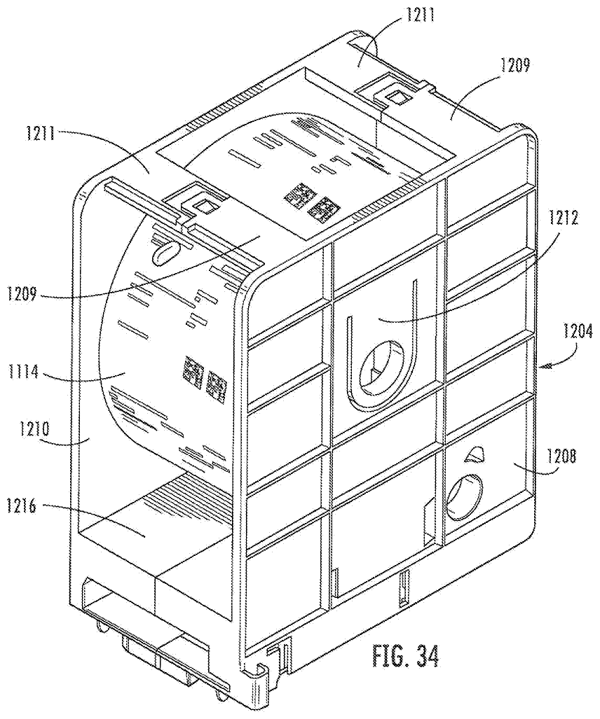

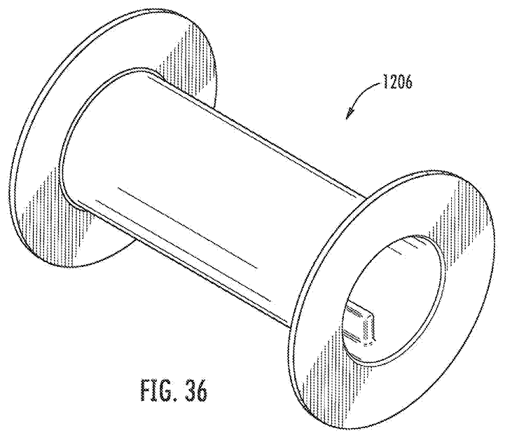

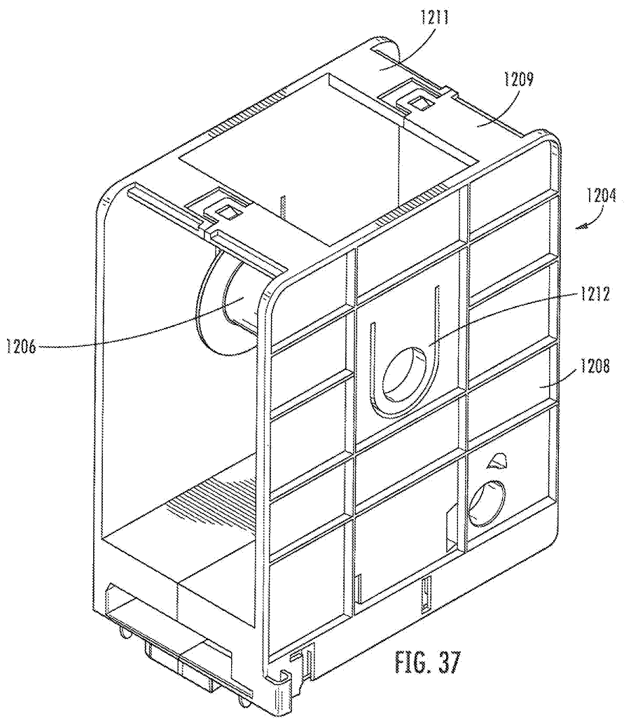

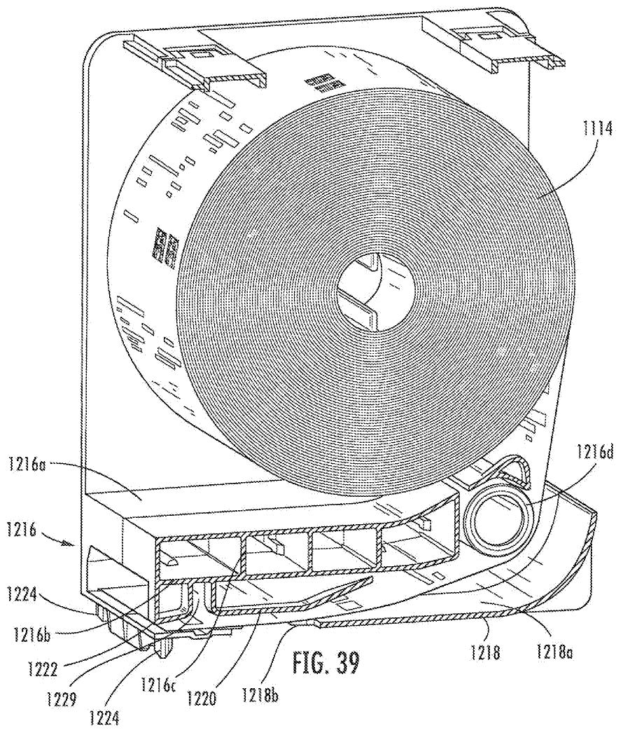

Referring now to FIGS. 34-40, the cartridge frame 1204 includes rectangular side walls 1208, 1210 rising from a floor 1216. Two support braces 1209 extend from side wall 1208 and interlock with corresponding support braces 1211 that extend from side wall 1210. Each side wall also includes corresponding tabs 1212, 1214 on which a free spinning hub 1206 (see FIGS. 36 and 37) is rotatably mounted. The tabs 1212, 1214 are deflectable to enable the hub 1206 to be easily installed and removed. As shown in FIG. 39, a rolled strip 1114 is mounted on the hub 1206.

As can be seen in FIG. 39, the floor 1216 has an open-celled configuration, with an upper surface 1216a and a lower surface 1216b separated by ribs 1216c. The upper surface 1216a is sloped at its rear end. An idle roller 1216d is located below the rear end of the floor 1216 and provides a movable arcuate surface to facilitate advancement of the strip 1114. A base 1218 (also curved at its rear end) is positioned below the lower surface 1216b and forms a gap 1218a through which the strip 1114 can travel.

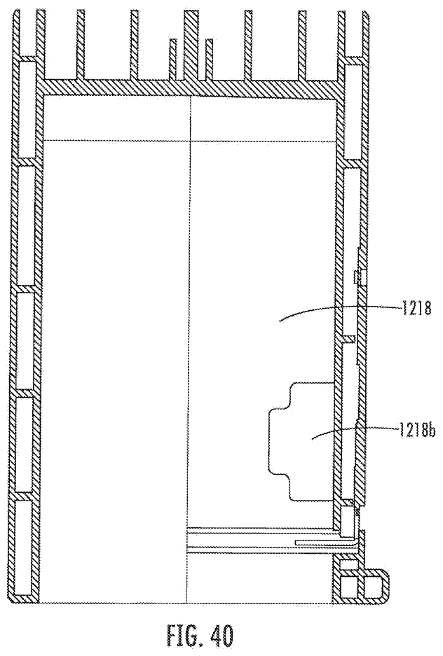

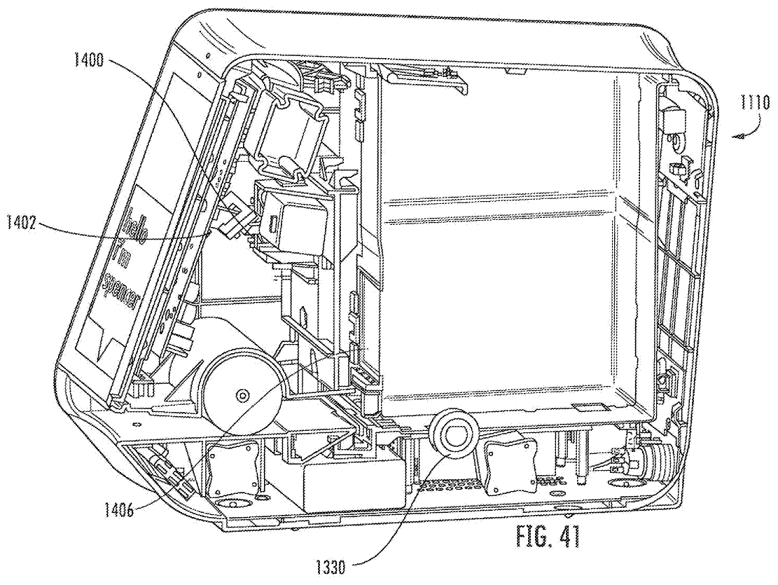

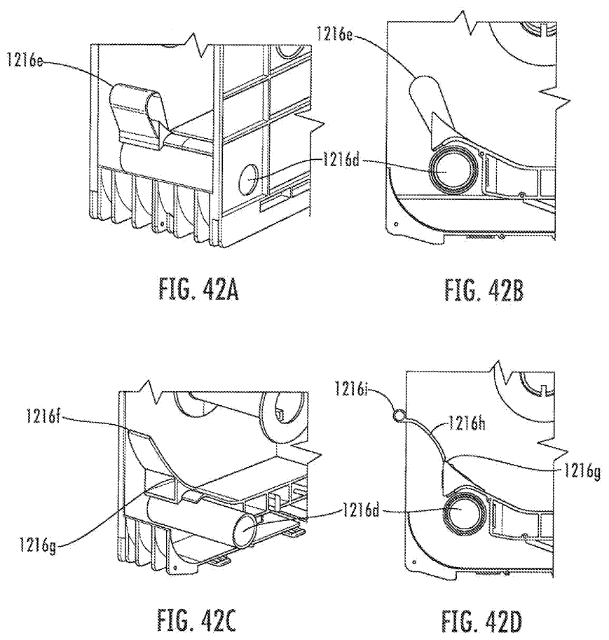

Referring to FIGS. 42A through 42D, the floor 1216 may include a flapper baffle 1216e, 1216f located at the rear above the idle roller 1216d. The flapper baffle 1216e, 1216f, 1216i is a flexible divider that extends from the floor 1216 into the space between the rolled strip 1114 and the portion of the strip 1114 that is separated from the roll as it enters the hole in the floor 1216. Because the roll naturally resists staying tightly wound, as the roll is spun during advancement of the strip 1114 to dispense a pouch, the outer layer of the roll tends to follow the portion of the strip that is leaving the roll to exit through the floor 1216; this often causes the roll to jam as the outer layer gets stuck with the moving strip 1114. The location and design of the flapper baffle 1216e, 1216f forces the roll to stay on the inside of the flapper baffle, thus preventing having the outer layer of the roll “hang up” in the exiting strip 1114, which is on the outside of the flapper baffle 1216e, 1216f. FIGS. 42A and 42B illustrate a looped flapper baffle 1216e, which can pivot at both attachment locations to allow flexibility during travel of the pouch strip 1114. The flapper baffle 1216e may be made from Mylar® or a similar polyester film or plastic sheet material. FIG. 42C illustrates an alternative flapper baffle 1216f comprising a thin, flat, extended bendable member which may have a living hinge 1216g or similar feature at its connection to the floor 1216 to allow flexibility during travel of the pouch strip. FIG. 42D illustrates another alternative flapper baffle 1216i that is convex relative to the travel path of the strip 1114 (in contrast, the flapper baffle 1216f is concave). The flapper baffles 1216f, 1216i may be made of polypropylene or a similar material. In some embodiments the flapper baffles 1216f, 1216i may be spring loaded in the forward direction so that it catches the roll and only the strip 1114 can get behind it. In some embodiments there is a fixed spacer 1216h located at the top of the flapper baffle 1216i so that the strip 1114 and roll are required to be separated by a set distance (determined by the size of the spacer 1216h). In other embodiments, such as that shown at 1216f, the flapper baffle has a sharp free edge to assist in separating the strip 1114 from the roll. The flapper baffles 1216e, 1216f, 1216i are of a width so as not to interfere with pills in the pouch (the flapper baffles 1216e, 1216f, 1216i are located to one edge of the strip 1114 and overlap a small portion of the width of the pouch).

A window 1218b is present in the base 1218 (see also FIG. 40) and receives a drive roller 1330 mounted to the dispenser that drives the pouch strip through the gap 1218a and out of the dispensing window 1202a in the cover 1202. It can also be seen that an elongate, rigid stop member 1220 depends from the lower surface 1216b of the floor 1216 to provide purchase against the drive roller 1330; in some embodiments, the lower surface of the stop member 1220 is treated to have low friction.

A spring 1221 extends transversely across the gap 1218a and can replace the arm 274 discussed above (see FIG. 27C). A spring release mechanism 1223 (FIG. 27D) can deflect the spring 1221 upwardly when the cartridge 1200 is inserted in the dispenser 1110 to enable the strip 1114 to more freely if desired.

A guide 1222 also projects from the lower surface 1216b near the dispensing window 1202a. Guide posts 1224 extend downwardly from the base 1218; these seat in holes in the cutter/exit assembly of the dispenser 1110 to align the cartridge 1200 and the dispenser 1110. A notch 1229 is present between the stop member 1220 and guide 1222 (FIG. 39).

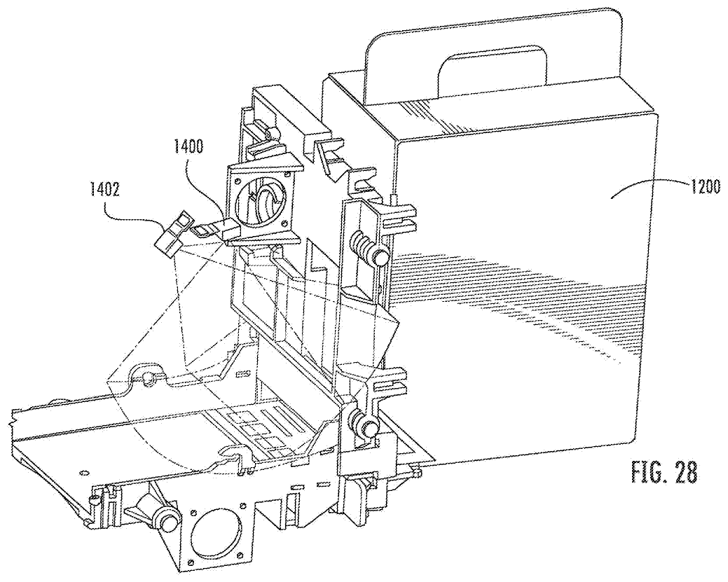

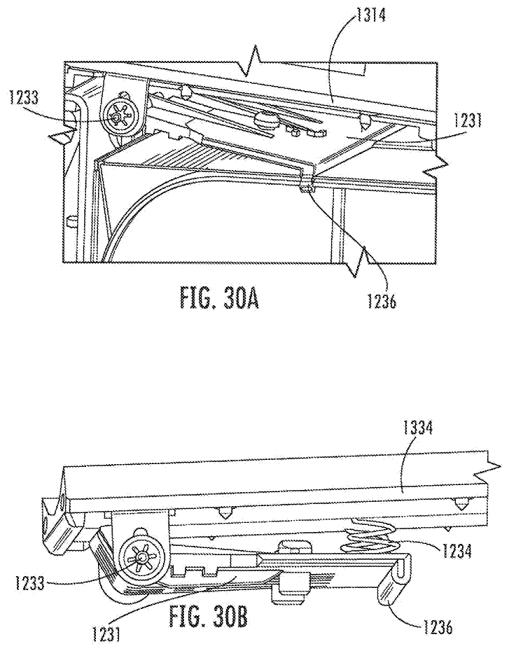

As can be seen in FIG. 28 and envisioned from FIG. 41, the cartridge 1200 fits within a cavity in the dispenser 1110 located above the drive roller 1330. The guideposts 1224 are received in receptacles in the dispenser 1110. The drive roller 1330 protrudes through the window 1218b (see FIG. 27C) and engages the stop member 1220 to form a nip through which the strip 1114 travels. The upper surface of the cartridge 1200 is held in place by a spring-loaded bracket 1231 that is pivotally attached to the door 1314 of the dispenser 1100 at a pivot 1233 and biased away from the door 1314 by a spring 1234 (see FIGS. 30A and 30B). A depending edge 1236 contacts the top surface of the cartridge 1200 and helps to maintain the cartridge 1200 in position by providing downward pressure on the cartridge 1200.

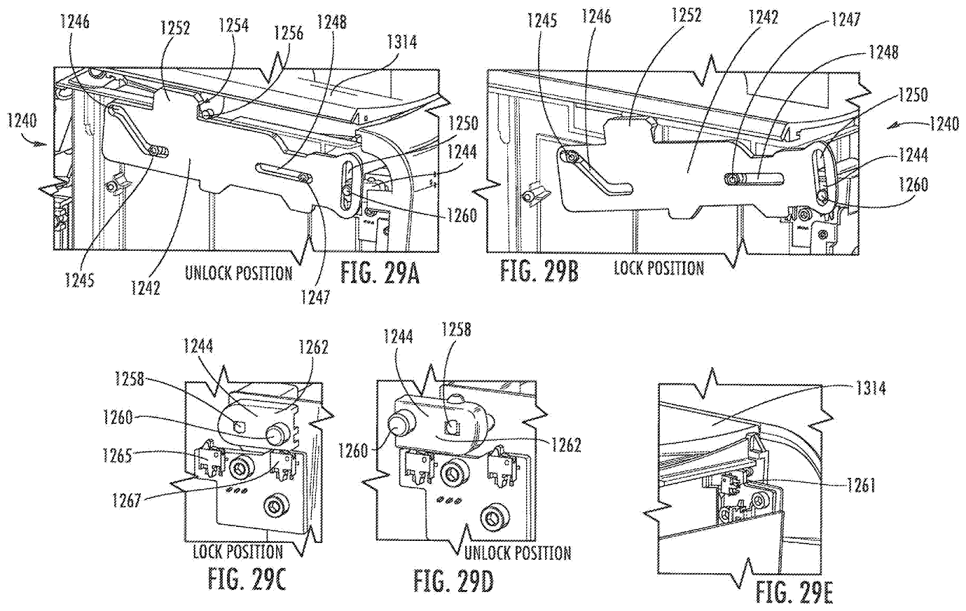

Referring now to FIGS. 29A-29E, a door locking mechanism 1240 is illustrated. The door locking mechanism 1240 includes a slide bar 1242 and a cam 1244. The slide bar 1242 has two slots 1246, 1248 in its main portion; the forward slot 1246 is tripartite, with its middle segment sloping downwardly and rearwardly. Posts 1245, 1247 mounted on the side wall of the dispenser 1110 are received in the slots 1246, 1248, respectively. The slide bar 1242 also includes a vertical slot 1250 at its rear end. A tab 1252 extends upwardly from the main portion of the slide bar 1242; a rim that follows the periphery of the tab 1252 forms a pocket 1254 that is open to the rear. A tab 1256 is mounted on the underside of the door 1314.

The cam 1244 (best seen in FIGS. 29C and 29D) is pivotally mounted onto the shaft 1258 of a motor mounted to the side wall of the dispenser 1110. A post 1260 is mounted on one end of the body 1262 of the cam 1244. The post 1260 is received in the vertical slot 1250 of the slide bar 1242.

As can be seen in FIGS. 29A and 29D, in the unlocked position, the cam 1244 is oriented so that the post 1260 is forward of the shaft 1258. In this position, the slide bar 1242 is forced forwardly, such that the posts 1245, 1247 are in the rear ends of the slots 1244, 1246. When a sensor 1261 mounted to the wall of the dispenser (FIG. 29E) detects that the door 1314 is closed, the system activates the motor to rotate the shaft 1258 (clockwise from the vantage point of FIG. 29D), which draws the slide bar 1242 rearwardly (guided by the posts 1245, 1247 in the slots 1244, 1246). As it moves rearwardly, the slide bar 1242 tilts so that its rear end rises and its front end descends. The rearwardly and angular movement of the slide bar 1242 positions the pocket 1254 to capture the tab 1256 on the door 1314, thereby locking the door 1314 in place (see FIGS. 29B and 29C). Sensors 1265 and 1267 are positioned to verify the position of the cam 1244 (see FIGS. 29C and 29D).

Referring now to FIGS. 28 and 41, the dispenser 1110 also includes two cameras 1400, 1402 mounted therein. The camera 1400 is mounted facing downwardly to take a “vertical” image of the pouch barcodes. The camera 1400 can also determine the position of the pouch strip for cutting of a pouch from the strip 1114 with the cutting assembly (thus, the camera 1400 can replace the sensor 340 discussed above). The camera 1402 is mounted to face downwardly and rearwardly in order to read both the pouch barcodes and the cartridge barcodes; the cartridge barcodes are affixed to the cover of the cartridge and are visible through a window 1406 in the compartment/cavity of the dispenser.

It should also be noted that FIGS. 27A and 27B illustrate a slightly different configuration of a cartridge frame 1204′. The cartridge frame 1204′ includes only one brace 1209′, 1211′ rather than two of each.

The present invention has been described herein with reference to flowchart and/or block diagram illustrations of methods, systems, and devices in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

It will be further appreciated that the functionality of any or all of the program modules may also be implemented using discrete hardware components, one or more application specific integrated circuits (ASICs), or a programmed digital signal processor or microcontroller. The program code may execute entirely on a single processor and/or across multiple processors, as a stand-alone software package or as part of another software package. The program code may execute entirely on an electronic device or only partly on the electronic device and partly on another device. In the latter scenario, the other device may be connected to the electronic device through a wired and/or wireless local area network (LAN) and/or wide area network (WAN), or the connection may be made to an external computer (for example, through the Internet using an Internet Service Provider).

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A cartridge for a pharmaceutical dispensing system, comprising:
a frame with opposed sidewalls and having a floor and a base, the floor positioned above the base and including a routing hole;
a plurality of individually sealed pouches of pharmaceuticals to be dispensed, the pouches formed as an elongate strip, the strip of pouches being wound into a roll over an axle member that extends between the sidewalls of the frame, wherein a free end of the strip extends through the routing hole in the floor and between the floor and the base;
wherein a flapper baffle extends from the floor to separate the roll from the free end of the strip, and wherein the flapper baffle comprises a looped member having opposed ends, the ends attached to the floor; and
wherein the ends of the looped member are pivotally attached to the floor.

2. The cartridge defined in claim 1, further comprising a brake member mounted between the floor and the base and configured to press the strip against the floor or the base to apply a braking force thereto.

3. The cartridge defined in claim 1, further comprising indicia related to contents and/or dispensing frequency of the pharmaceuticals in the pouches.

4. The cartridge defined in claim 1, wherein the axle is removably mounted to the sidewalls of the frame.

5. The cartridge defined in claim 2, wherein the brake member comprises a biasing member that is configured to press the strip against the floor.

6. The cartridge defined in claim 1, wherein the base includes a hole configured to receive a drive roller that advances the strip from the cartridge.

7. The cartridge defined in claim 1, further comprising a cover that overlies the frame.

8. The cartridge defined in claim 1, wherein the flapper baffle comprises a hinge.

9. The cartridge defined in claim 1, wherein the flapper baffle is spring-loaded.

10. The cartridge defined in claim 1, wherein the flapper baffle comprises a fixed spacer.
